(19) United States
(12) Patent Application Publication
(10) Pub. No.: US 2004/0096058 A1
(43) Pub. Date: May 20, 2004

(54) Apparatus and method for encrypting/decrypting information on basic element by element basis and encryption/decryption system using the same

(76) Inventors: Young-Sun Cho, Seoul (KR); Young-Sik Nam, Gyeonggi-do (KR); Woo-Jin Lee, Seoul (KR); Hee-Seok Kang, Gyeonggi-do (KR); Seok-Jin Park, Seoul (KR)

Correspondence Address: KILPATRICK STOCKTON LLP, 607 14TH STREET, N.W., SUITE 900, WASHINGTON, DC, 20005, US

(21) Appl. No.: 10/475,827

(22) PCT Filed: Apr. 26, 2002
(86) PCT No.: PCT/KR02/00788

(30) Foreign Application Priority Data
Apr. 27, 2001 (KR) 2001-23118
May 24, 2001 (KR) 2001/28787

(51) Int. Cl. H04K 1/00

(52) U.S. Cl. 380/28

(57) ABSTRACT

An apparatus and method for encrypting/decrypting information, and the encrypting/decrypting system using the same, and a computer readable recording medium storing programs for realizing the above are disclosed. A method for encrypting information on a basic element-by-basic element basis, includes the steps of: a) receiving information to be encrypted; b) generating random number maps; c) decomposing the information into a plurality of basic elements which are classified into multiple channels; d) encrypting the basic elements and generating encrypted information; and e) outputting the encrypted information.

### TECHNICAL FIELD

The present invention relates to an apparatus and method for encrypting/decrypting information, and the encrypting/decrypting system using the same, and a computer readable recording medium storing programs for realizing the above; and, more particularly, to an apparatus and method for encrypting/decrypting information in which an image is encrypted by re-arranging basic elements of the image and changing colors of the image on a basic element by basic element basis under the use of a personal security code, an encryption key managed by an authorized organization, a high security encryption algorithm and a random numbers algorithm, so that a decryption of the encrypted image is impossible without an exclusive decrypting apparatus, an encrypting/decrypting system using the same, and a computer readable recording medium storing programs for the realization of the above.

### BACKGROUND ART OF THE INVENTION

First of all, a basic element of a pixel used in this specification will be described.

As most generally used reference models, there are a red, green and blue (RGB) model for color monitors or video cameras, a cyan, magenta and yellow (CMY) model and a cyan, magenta, yellow and black (CMYK) model for a color printer, a luminance, inphase and quadrature (YIQ) model for color televisions, a hue, saturation and intensity (HSI) model used for editing of color images, and a hue, saturation and value (HSV) model. The values of models can be transformed to each other based on certain transformation equations.

In the present invention, any one of the RGB, CMY, CMYK, YIQ, HIS and HSV models can be used as “basic element of a pixel” (hereinafter, referred to as “basic element”). However, in this specification, for easy description, only the RGB model is described as the basic element.

In general, forged passports are being used for international terrorism, drug contraband, smuggling into a country, etc., and forged identification cards are being used for different kinds of crimes such as employment of a minor at a red-light district, real estate swindling, identity fraud of a criminal, etc., causing serious damage socially and nationally. Also, since a seal impression of a bankbook, or a signature of a credit card, etc. are printed and exposed intact as the original, it is not difficult to forge them when robbed or lost even though the forger is not an expert, causing different kinds of financial accidents such as unlawful withdrawal of a deposit, etc. Furthermore, forgery of holograms of credit cards, department store gift certificates, trademarks, etc. happens frequently.

Conventionally, special printing technologies such as non-fluorescence, optical interference pattern, micro-lettering, intaglio, security thread and watermark are applied in a combination, but forgery still remains as serious as to be called a history of a war against forgers. For these reasons, many countries are investing their human and material resources for the prevention of forgery.

Up to now, accurate printing technologies, with the use of special materials, such as bar code, hologram, watermark and micro lettering have been used as a forgery preventing method for printings. However, these special printings may make the forgery difficult, but they cannot fundamentally prevent the forgery, due to the remarkable development of a color copy machine and a computer technology together with the development of the forgery techniques by expert forgery organizations.

The development of such forgery techniques is one problem, but another reason for the ceaseless forgery is that the general public is not able to determine easily whether something is forged or not. Considering that forgery is caused by the lack of knowledge or carefulness of the general public in determining whether something is forged or not easily, such forgery can be settled if a method of simply informing the forgery.

A basic concept and method of an image information security system is disclosed in a Korea Patent Application No. 1999-2625 filed by the same applicant of the present invention on Jan. 27, 1999. In the application, an image is read by an image sensor and then the image is separated into minute pieces based on regular triangle shape, re-arranging positions of the pieces according to a given security code, encrypting by only increasing the number of the re-arrangements. Even though the above method takes a long time in decrypting with the current computer system, the time will be rapidly shortened, considering the present development trend of the computer technology. A method having a higher security than that of Korean Patent application 1999-2625, was filed with the Korean Intellectual Property Office by the same applicant of the present invention under the title of “Method and apparatus for encrypting an image” (Korea Patent Application No. 2000-66708) on Nov. 10, 2000. The image information security system of the patent application No. 2000-66708 is highly secure at the present, however, in order to strengthen the security more, the image has to be decomposed into smaller elements than the pixels, and it is also needed introduction of the steganography to the encryption of the image.

Accordingly, it is necessary a new encryption method in which a high security algorithm and a multi step encryption are utilized and an image is encrypted on a basic element by basic element basis differentiating from the conventional methods. By employing such new encryption method, encryption (issuance) apparatus for preventing forgery, and a practical decryption (decoding) apparatus, could be easily used not only by experts but also by general public.

### SUMMARY OF THE INVENTION

Therefore, it is an object of the present invention to provide an encryption apparatus, a method thereof and a computer readable recording medium storing programs to realize the inventive method, in which an input image is encrypted by being decomposed into a plurality of basic elements and puzzled, and then positions of the pixels being changed irregularly.

Another object of the present invention is to provide an encryption apparatus, a method thereof and a computer readable recording medium storing programs to realize the inventive method, in which an input image is encrypted by being decomposed into a plurality of basic elements and puzzled, and then positions as well as colors of the basic elements are changed irregularly.

A further another object of the present invention is to provide an encryption apparatus, a method thereof and a computer readable recording medium storing programs to realize the inventive method, in which an input image is encrypted based on a personal security code, an encryption key code managed by an authorized organization, a high security encryption algorithm with guaranteed stability, a random number algorithm and a gray scale map.

A further another object of the present invention is to provide an image encryption apparatus, a method thereof and a computer readable recording medium storing programs to realize the inventive method, in which an image is concealed by using an optical illusion.

A further another object of the present invention is to provide an image encryption apparatus, a method thereof and a computer readable recording medium storing programs to realize the inventive method, in which forgery executed by a third party besides the corresponding authority is impossible.

A further another object of the present invention is to provide a decryption apparatus, a method thereof and a computer readable record of the programs to realize the inventive method, in which the encrypted image on a basic element by element basis in real time and informs whether there is forgery in the decrypted information or not.

A still further another object of the present invention is to provide an encryption/decryption system and method thereof, which are gotten by mutually interlocking the above encryption apparatus and method and the above decryption apparatus and method, and to provide a computer readable record of the programs to realize the inventive method.

In accordance with an aspect of the present invention, there is provided a method for encrypting information on a basic element-by-basic element basis, including the steps of: a) receiving information to be encrypted; b) generating random number maps; c) decomposing the information into a plurality of basic elements which are classified into multiple channels; d) encrypting the basic elements and generating encrypted information; and e) outputting the encrypted information.

In accordance with another aspect of the present invention, there is provided a method for decrypting information on a basic element-by-basic element basis, including the steps of: a) receiving an encrypted information; b) obtaining a security code used for decrypting the encrypted information; c) generating random number maps; d) decrypting the encrypted information on a basic element by basic element basis and generating decrypted basic elements; e) composing the decrypted basic elements and generating restored information; and f) outputting the restored information.

In accordance with another aspect of the present invention, there is provided an apparatus for encrypting information on a basic element by basic element basis, including: an input unit for receiving information to be encrypted; a security code obtaining unit for obtaining a security code; an encryption unit for decomposing the information into multiple channels of basic elements and for encrypting the basic elements, thereby generating an encrypted information; a storing unit for storing the encrypted information; and an output unit for outputting the encrypted information.

In accordance with further another aspect of the present invention, there is provided an apparatus for decrypting information on a basic element by basic element basis, including: an input unit for receiving an encrypted information; a security code obtaining unit for obtaining a security code; a decryption unit for decrypting the encrypted information on a basic element by basic element basis, composing the decrypted basic elements and generating restored information; a storing unit for storing the restored information; and an output unit for outputting the restored information.

In accordance with still further another aspect of the present invention, there is provided A method for encrypting/decrypting information on a basic element-by-basic element basis, including the steps of: a) receiving information to be encrypted; b) generating random number maps for an encryption; c) decomposing the information to be encrypted into a plurality of basic elements; d) performing a multi step encryption of the basic elements and generating encrypted information; e) outputting the encrypted information; f) receiving the encrypted information; g) obtaining a security code used for decrypting the encrypted information; h) generating random number maps for a decryption; i) performing a multi step decryption of the encrypted information on a basic element by basic element basis; j) restoring an original image by composing the decrypted basic elements and generating restored information; and k) outputting the restored information.

In accordance with still further another aspect of the present invention, there is provided an apparatus for encrypting/decrypting information on a basic element-by-basic element basis, the apparatus including: an input unit for receiving encrypted information and information to be encrypted; a security code obtaining unit for obtaining a security code for an encryption; a multi step encryption unit for performing a multi step encryption by decomposing the information into a plurality of basic elements, and changing a position of the basic element based on a random number map for an encryption and a color of the basic element based on a gray scale map; a security code obtaining unit for obtaining a security code used for decrypting the encrypted information; a multi step decryption unit for performing a multi step decryption by inverse-changing the position of the basic element based on the random number map and the color of the basic element based on the gray scale map, and then, restoring original information by composing the decrypted basic elements and generating restored information; a storing unit for storing the encrypted information and the restored information; and an output unit for outputting the encrypted information and the restored information.

In accordance with still further another aspect of the present invention, there is provided a computer readable recording medium storing instructions for executing a method for encrypting information on a basic element-by-basic element basis, the method including the steps of: a) receiving information to be encrypted; b) generating random number maps; c) decomposing the information into a plurality of basic elements which are classified into multiple channels; d) encrypting the basic elements and generating encrypted information; and e) outputting the encrypted information.

In accordance with still further another aspect of the present invention, there is provided a computer readable recording medium storing instructions for executing a method for decrypting information on a basic element-by-basic element basis, the method including the steps of: a) receiving an encrypted information; b) obtaining a security code used for decrypting the encrypted information; c) generating random number maps; d) decrypting the encrypted information on a basic element by basic element basis and generating decrypted basic elements; e) composing the decrypted basic elements and generating restored information; and f) outputting the restored information.

In accordance with yet another aspect of the present invention, there is provided a computer readable recording medium storing instructions for executing a method for encrypting/decrypting information on a basic element-by-basic element basis, the method including the steps of: a) receiving information to be encrypted; b) generating random number maps for an encryption; c) decomposing the information to be encrypted into a plurality of basic elements; d) performing a multi step encryption of the basic elements and generating encrypted information; e) outputting the encrypted information; f) receiving the encrypted information; g) obtaining a security code used for decrypting the encrypted information; h) generating random number maps for a decryption; i) performing a multi step decryption of the encrypted information on a basic element by basic element basis; j) restoring an original image by composing the decrypted basic elements and generating restored information; and k) outputting the restored information.

The apparatus for the encryption/decryption method of this invention is embodied by an issuance apparatus (encryption apparatus) to which a forge preventing technique is applied, and by a decoding apparatus (decryption apparatus), which is capable of determining whether there is forgery of not.

In the above issuance apparatus, an encryption method and a hacking preventing technology capable of protecting, in the most efficient way, an image of a limited space area such as photo, signature, seal impression, peculiar pattern, etc., are applied.

The encryption method prevents a possibility of the forge doubly, trebly by employing a personal security code and an encryption key managed by an authorized organization, a high security encryption algorithm with guaranteed stability, and a random number algorithm. Especially, it is included a procedure of decomposing the image into a plurality of basic elements, puzzling each channel of basic elements by re-arranging the basic elements irregularly according to the random number algorithm and mapping the puzzled basic elements to the one-color gray scale map and re-puzzling by combining multiple channels of the basic elements mapped to the gray scale map and re-arranging the combined basic elements irregularly.

Here, one-step encryption is possible even with the procedure of making the image puzzled on a basic element-by-basic element basis. That is, the color converting procedure is an additional component. In this specification, a multi step encryption and decryption will be described, however, it is apparent to one skilled in the art that one-step encryption can be applied to all following embodiments.

As stated above, in the present invention, the image is changed on a basic element-by-basic element basis according to the random number algorithm and an encryption algorithm, to thereby make the decryption impossible without an exclusive decrypting apparatus, and make the forgery of identification card, card, paper money and bankbook, impossible. Further, in case that there is a miscellaneous image, the image is restored using the multi step image processing technique, to thus obtain a stable restoration.

### BRIEF DESCRIPTION OF THE DRAWINGS

The above and other objects and features of the present invention will become apparent from the following description of preferred embodiments along with the attached drawings, in which:

FIG. 1A shows that an image having red (R), green (G), blue (B) and white (W) elements is decomposed into a plurality of pixels in accordance with the present invention;

FIG. 1B shows a red channel of basic elements in the decomposed image in accordance with the present invention;

FIG. 1C shows a green channel of basic elements in the decomposed image in accordance with the present invention;

FIG. 1D shows a blue channel of basic elements in the decomposed image in accordance with the present invention;

FIG. 1E shows a red channel of puzzled basic elements in accordance with the present invention;

FIG. 1F shows a green channel of puzzled basic elements in accordance with the present invention;

FIG. 1G shows a blue channel of puzzled basic elements in accordance with the present invention;

FIG. 1H shows a red channel of basic elements mapped into one-color gray scale map in accordance with the present invention;

FIG. 1I shows a green channel of basic elements mapped into one-color gray scale map in accordance with the present invention;

FIG. 1J shows a blue channel of basic elements mapped into one-color gray scale map in accordance with the present invention;

FIG. 1K shows basic elements which are combined and re-puzzled in accordance with the present invention;

FIG. 1L shows an image in which re-puzzled basic elements are converted to pixels in accordance with the present invention;

FIG. 1M shows an image in which characters “ [symbol] ” is overlapped to an encrypted image of FIG. 1K in order to conceal the encrypted image with an optical illusion;

FIG. 1N shows an image in which characters “ [symbol] ” is overlapped to an encrypted image of FIG. 1L in order to conceal the encrypted image with an optical illusion;

FIG. 2 is a block diagram for an encryption apparatus on a basic element-by-basic element basis in accordance with an embodiment of the present invention;

FIG. 3 is a block diagram for a decryption apparatus a basic element-by-basic element basis in accordance with an embodiment of the present invention;

FIG. 4 is a flowchart illustrating an encryption method a basic element-by-basic element basis in accordance with an embodiment of the present invention;

FIGS. 5A and 5G provide flowcharts illustrating multi step encryption procedures a basic element-by-basic element basis in FIG. 4;

FIG. 6 depicts a flowchart illustrating a decryption method a basic element-by-basic element basis in accordance with the present invention; and

FIGS. 7A and 7G set forth flowcharts for multi step decryption procedures a basic element-by-basic element basis in FIG. 6.

### MODES FOR CARRYING OUT THE INVENTION

Hereinafter, preferred embodiments of the present invention will be described in detail with reference to the accompanying drawings.

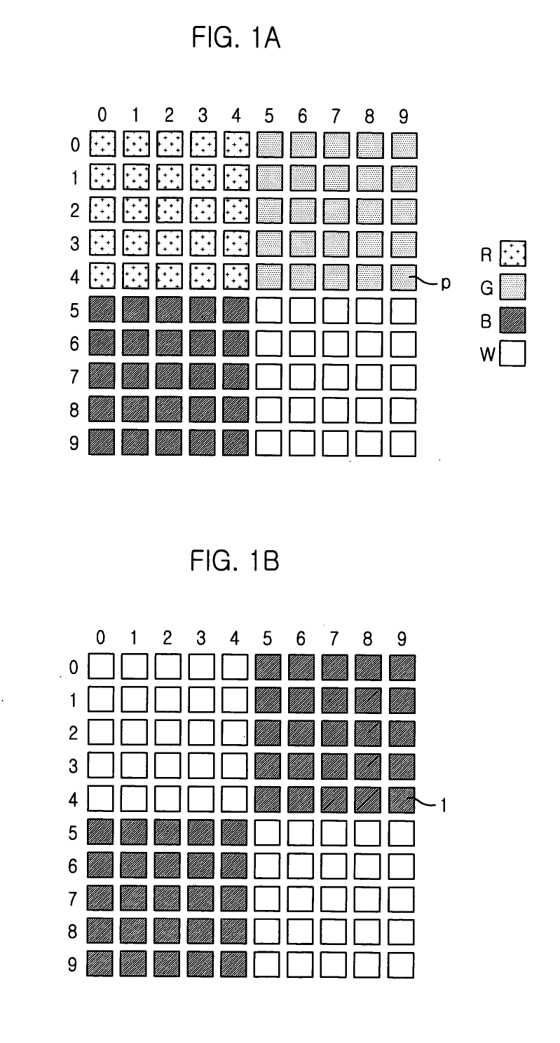

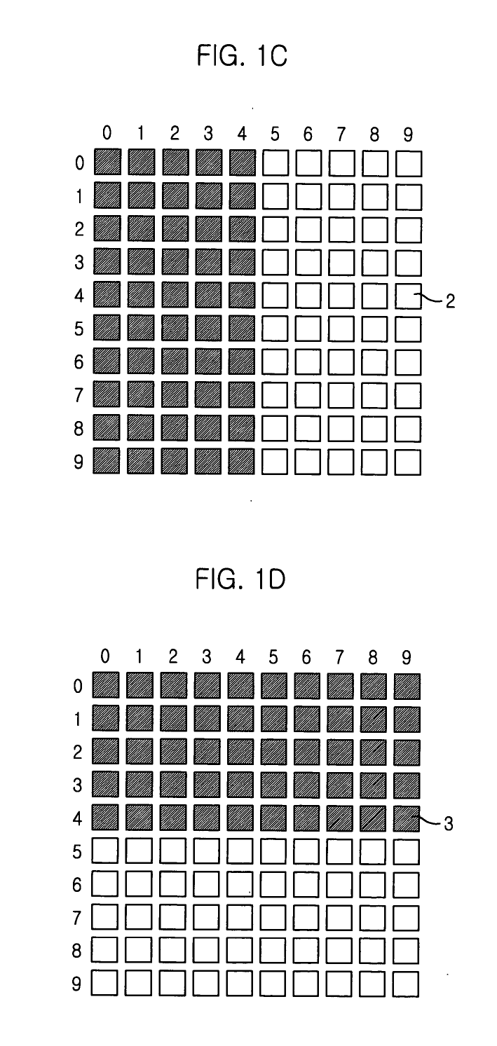

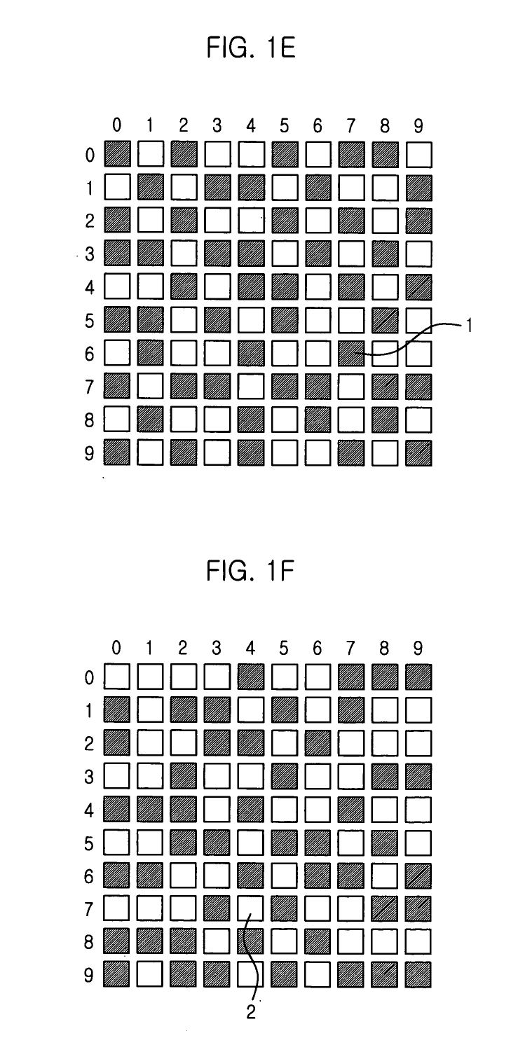

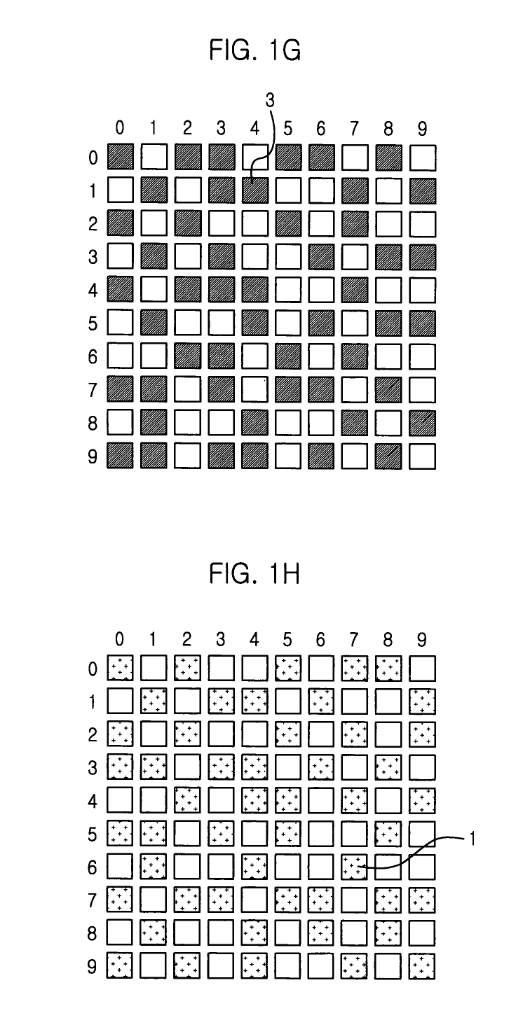

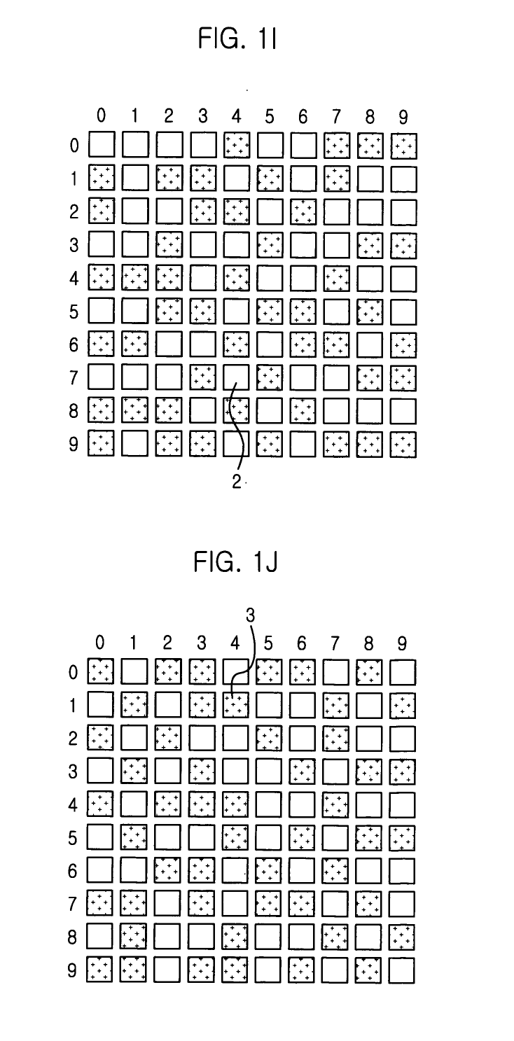

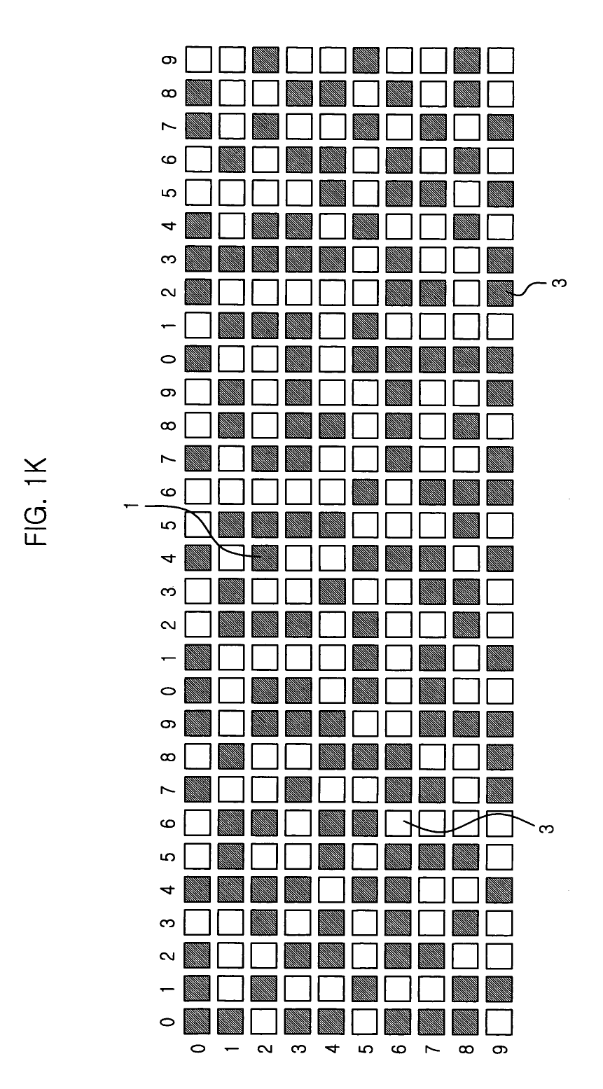

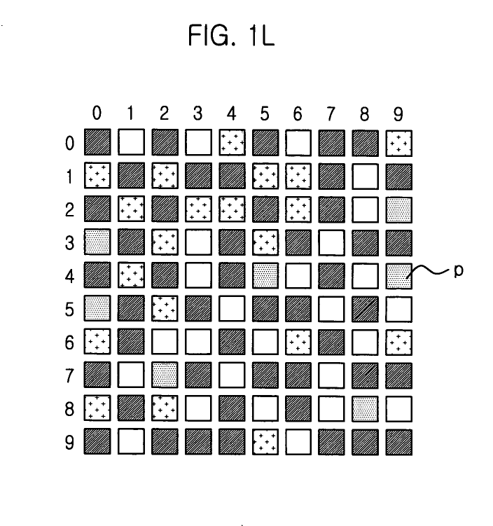

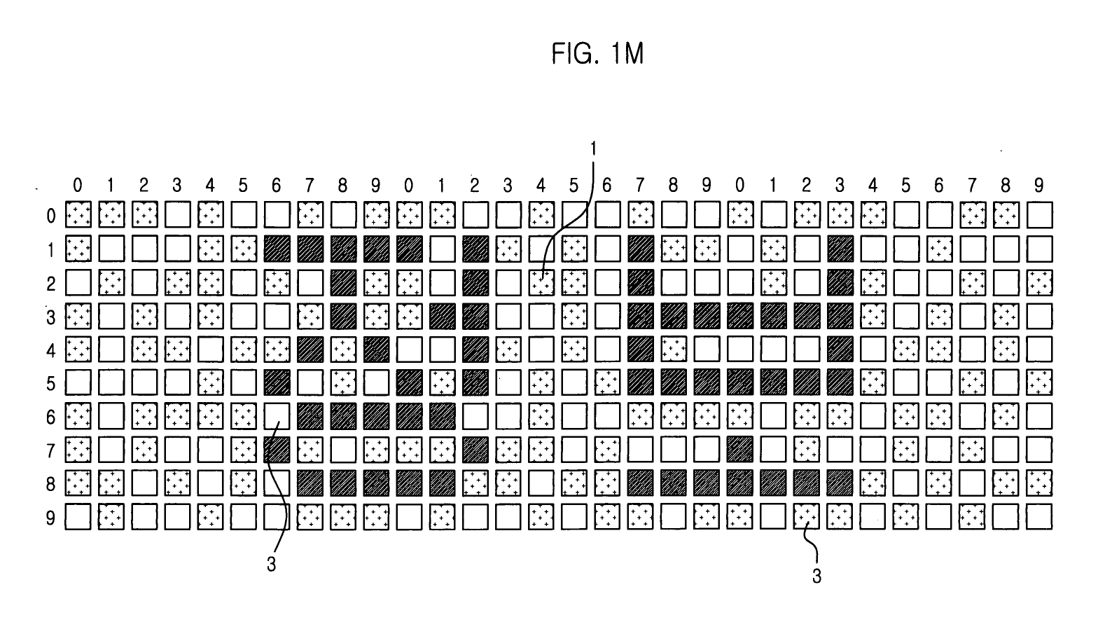

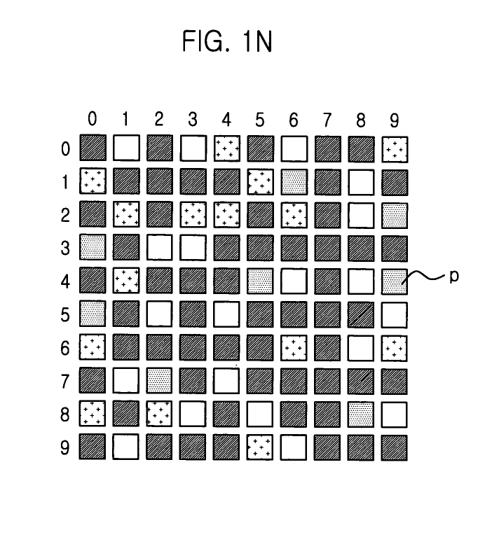

With reference to FIGS. 1A through 1N, a technical gist of the present invention can be described as follows.

In accordance with the present invention, an encryption method largely includes a pre-processing procedure, a multi step encryption procedure and a post-processing procedure.

The pre-processing procedure includes an input procedure and a normalization procedure.

This input procedure is the procedure of inputting analog type information such as an image or a text, through an image input unit, and converting it into digital information, or the procedure of transferring existing information already digitized from a database to an encryption apparatus. Here, the image input unit can be an image sensor, a camera or a scanner, etc., and database means a large of the images stored in a predetermined form, which has already been received through the image input unit. The inputted image goes through a multi step encryption procedure after a normalization procedure.

In the normalization procedure, a color and a size of the inputted image are adjusted. The inputted image through the image input unit, except of the digital image stored at the database, is changed from analog data to digital data, thus, its color is controlled to maintain the color of the original image as much as possible. The size is controlled considering the correlation with the neighboring pixel to gain the most approximate image to the original image, lessening as much as possible the data loss of the inputted image.

The second multi step encryption procedure contains a decomposing procedure of the image into a plurality of pixels, a puzzling of the basic elements and a mapping procedure of the basic elements to one-color gray scale map, which will be described in detail later.

The third post-processing procedure contains an encrypted image outputting procedure.

In the encrypted image outputting procedure, the encrypted image is outputted as digital information or is printed on a printing sheet according to its application. At this time, since the outputted image from the printer is a combination of pieces entirely different from the original image, it is impossible to know the original image. For example, in case of encrypting a photo of a passport or an identification card, or personal information etc., (e.g., encrypting with yellow color), it is printed in yellow without any shape. Therefore, if the background of the passport is yellow, it can obtain even the effect of concealment. Also, in case of printing text on the encrypted image, the text may act as noise but it would have almost no influence in restoring the original image.

The detailed technical gist on the encryption method of the present invention is described as follows.

The encryption method of this invention includes procedures of generating random number maps, decomposing image into a plurality of basic elements, puzzling the basic elements based on the random number maps, generating a one-color gray scale map, and mapping the basic elements to the one-color gray scale map, combining the multiple channels of the basic elements, re-puzzling the combined basic elements based on the random number map and converting the basic elements to the pixels.

Herewith, the procedure of re-puzzling the basic elements using the random number map and converting the basic elements to the pixels are not essential components of the invention, but additional ones. In the procedure of generating one-color gray scale map and mapping the basic elements to the one-color gray scale map, though it is described the case of mapping the basic elements to the one-color gray scale map, the basic elements can be mapped not only to the one-color gray scale map but also a two-color gray scale map or a multi-color gray scale map.

Further, the procedure of decomposing the information into a plurality of basic elements is a procedure of decomposing the information inputted through the image input unit into a plurality of basic elements in order to increase the security of the encrypted image. In this specification, the information includes an image, a text, etc., however, for only easy description, only the image is described as the object to be encrypted or decrypted.

Referring to FIGS. 1A to 1D, FIG. 1A represents an image decomposed into pixels each having pure colors like red (R), green (G), blue (B) and white (W) in accordance with the present invention, FIG. 1B represents a red channel of basic elements. FIG. 1C represents a green channel of basic elements. FIG. 1C represents a blue channel of basic elements. A pixel p in FIG. 1A is decomposed into a first basic element 1 in FIG. 1B, a second basic element 2 in FIG. 1C and a basic element 3 in FIG. 1D.

In the procedure of generating the random number map, it can be used a random number generator only, or a random number generator with a random number map generator. Now, the random number generator can utilize various algorithms such as a data encryption standard (DES) and SEED etc. The random number maps are provided to process two steps of puzzling (equally applied to decryption), and seven random number maps are generated. Among seven random number maps, six ones (the number of the channels of the basic elements×two steps) are used for a primary puzzling (a primary encryption) and one for re-puzzling (a third encryption) after combining multiple channels of the basic elements.

Here, six random number maps are used for the puzzling procedure as shown in FIGS. 1E to 1G, and the last random number map is used for the re-puzzling procedure (third encryption) as shown in FIG. 1M.

In case that the re-puzzling procedure is an option, only six random number maps can be generated, or after generating seven random number maps, it is possible for the last one not to be used.

The six random number maps are used for performing two steps of puzzling the three channels of the basic elements. In the two random number maps used for each channel of the basic elements, the first one is used for a substitution on matrix unit basis, and the second one is used for a substitution on a pixel-by-pixel basis. Here, the substitution on matrix unit basis means that positions are changed row with another row, and column with another column, and the substitution based on a pixel-by-pixel basis means that positions are changed pixel with another pixel.

There are two reasons why the random number map is applied by two steps like the above. The first reason is that the encryption keys used to generate respective random number maps are different, getting this way a higher security and higher stability, and the second reason is the ability to generate the needed random number map of a uniform distribution.

According to two random number maps above-mentioned, the first basic element 1 of FIG. 1B is changed to a first basic element 1 of FIG. 1E, the second basic element 2 of FIG. 1C is changed to a second basic element 2 of FIG. 1F, the third basic element 3 of FIG. 1D is changed to a third basic element 3 of FIG. 1G.

The second encryption procedure includes a first step of generation one-color gray scale map and a second step of mapping the basic elements into the one-color gray scale map. If an image to be encrypted is represented by the one-color gray scale, the image is to be encrypted based on another color of the one-color gray scale map. The one-color gray scale map is generated in consideration of easy application. For example, a yellow, gray, white or black color of gray scale map can be used, the yellow or white color of gray scale map can be properly applied when printing the encrypted image on the paper.

Based on the one-color gray scale map above-mentioned, the first basic element 1 of FIG. 1E is changed to a first basic element 1 of FIG. 1H, the second basic element 2 of FIG. 1F is changed to a second basic element 2 of FIG. 1I, the third basic element 3 of FIG. 1G is changed to a third basic element 3 of FIG. 1J.

The third encryption procedure is a procedure of combining the three channels of basic elements and re-puzzling combined basic elements based on a random number map. In other words, the basic elements generated in the second encryption procedure are re-puzzled based on the last random number map. The re-puzzling procedure increases the security of the encryption.

According to the last random number map above-mentioned, the first basic element 1 of FIG. 1H is changed to a first basic element 1 of FIG. 1K, the second basic element 2 of FIG. 1I is changed to a second basic element 2 of FIG. 1K, the third basic element 3 of FIG. 1J is changed to a third basic element 3 of FIG. 1K.

Meantime, a procedure of converting basic elements to pixels means a procedure of combining the three basic elements to generate a pixel. According to the procedure of converting basic elements to pixels, a pixel p in FIG. 1L is generated, which corresponds to the pixel p in FIG. 1A. As mentioned above, this conversion procedure is not an essential component but an additional one. If the conversion procedure is not performed, the three basic elements are converted into three pixels. At this time, the other two basic elements corresponding to one element are generated as dummy data. For example, there is the R channel of the basic element which is encrypted, G and B channels of basic elements are additionally generated, and then, the R, G and B channels of the basic elements converted to a pixel. Therefore, the volume of data is three times than that in case of combing the three basic elements. In other words, by converting the basic elements to the pixels, the volume of the data can be reduced by one third.

Text can be processed regarding the letter shape itself as an image, or using a code representing the letter shape. The former can be processed by the above-described method, and the latter can be processed by optionally defining a color corresponding to bits which constitute the code, for instances, 0 is white and 1 is black, etc.

On the other hand, as afore-mentioned, by using the encrypted image generated based on the same color of the one-color gray scale map as the background color of the information, it can obtain the effect of the concealment. If the encrypted image is generated in a specific color (e.g., yellow), and printed on a specific portion of a printing sheet of the same color (e.g., yellow printing sheet) at its application procedure, illegal forgers would not be able to know even where the encryption is. Also, in case of using several colors (e.g., red, orange, yellow, green, blue, dark blue, purple etc.), the same effect can be obtained by utilizing various colors as the background color of the printing sheet.

Using the method mentioned above, characters “ [symbol] ” are overlapped on the encrypted image in FIG. 1K, and then, an image in FIG. 1M is obtained. Character “ [symbol] ” is overlapped on the encrypted image in FIG. 1L, and then an image in FIG. 1N is obtained.

Though an application method in printing the encrypted image was described in the above example, it can also be applied differently like storing the encrypted image as digital information, or transmitting the encrypted image to a decoding apparatus through a transmitting apparatus.

Meanwhile, the decryption method is processed in inverse-order of the above encryption method.

In accordance with the present invention, the decryption method includes an encrypted image pre-processing procedure, a multi step decryption procedure, and a post-processing procedure.

The first pre-processing procedure includes an input procedure and a normalization procedure.

The input procedure is the procedure of inputting information of an analog type encrypted image printed on peculiar material such as paper, plastic etc. through the image input unit, or a digital encrypted information from a database.

As an example of this invention, an analog type encrypted image printed on the paper read by the image input unit is digitized, and transferred to a multi step decoding procedure. Therefore, before transferring to the decryption procedure, a normalization procedure correcting input error generated in the input process is needed.

In the normalization procedure, the skew and the size are corrected.

The skew correcting procedure operates when the inputted image through the image input unit is different from the original skew. If the skew error caused in the input process is not corrected, not only a necessary data area and an unnecessary data area cannot be distinguished, but also it influences on procedures that take place later.

The size correcting procedure is the procedure to control the size by the number of minimum blocks required when the encrypted image goes through the decryption procedure. In this case, a maximum accumulative differential value in a three-dimensional frequency domain is used because the interference effect generated in the input of the encrypted image to constituting pixels becomes minimum.

The second multi step decrypting procedure includes an inverse-puzzling procedure and a color-restoring procedure, which will be described later, in more details.

The third post-processing procedure is the image correction procedure which includes a primary restoration procedure and a secondary restoration procedure. In case there is a miscellaneous image on the image, it may execute a primary restoration procedure through the use of a spatial filtering technique, which has an optimum similarity using information of a neighboring pixel. Further, in case that neighboring pixels are all part of the miscellaneous image, it may execute a secondary restoration procedure of performing an inverse-estimation and a restoration by utilizing a restoration value of the neighboring pixel.

Next, the detailed technical gist on this invention's decryption method is described as follows.

This invention's decryption method includes procedures of generating a random number map, decomposing the encrypted image to the basic elements, inverse-puzzling of the basic elements based on the random number map, diving the basic elements into three channels of basic elements, generating a one-color gray scale map, inverse-mapping the inverse-puzzled basic elements into the one-color gray scale map, re-inverse-puzzling each channel of the basic elements by using the random number map, and converting the decrypted basic elements to the pixels, and correcting the decrypted image. Further, more description of the above respective procedures will be hereby omitted as this procedure can be easily known by those skilled in this field referring to process operations of each procedure described in detail in the above encryption method.

Here, the procedures of decomposing the pixel of the encrypted image into the basic elements, inverse-puzzling the basic elements based on the random number map, and correcting the decrypted image are not essential components but additional ones. Though mapping of the basic elements into the one-color gray scale map is described as an example in this specification, as mentioned above in the encryption procedure, the basic elements can be mapped into the two-color or multi-color gray scale map.

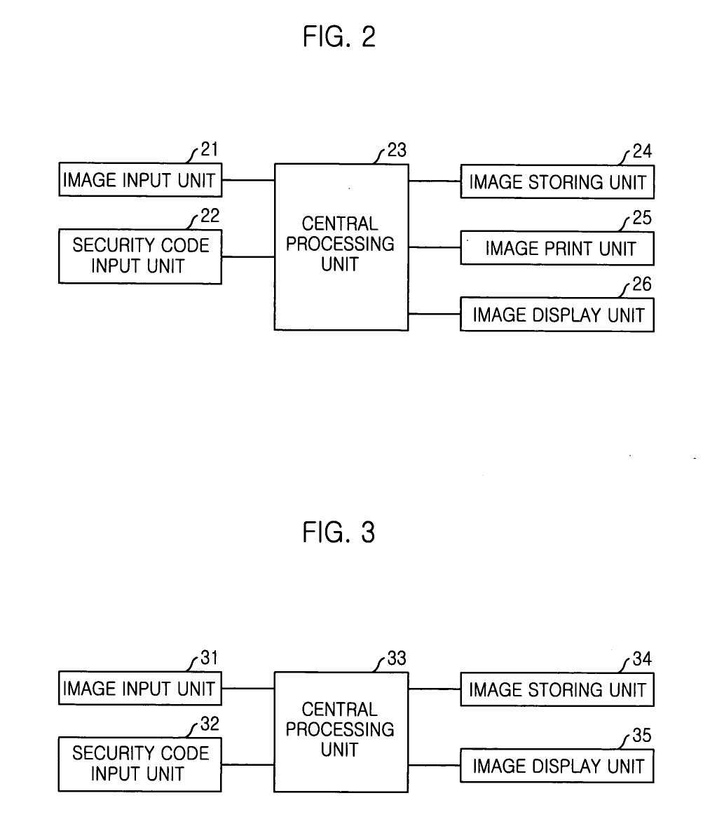

FIG. 2 is a block diagram of an encryption apparatus on a basic element-by-basic element basis in accordance to this invention.

Referring to FIG. 2, this invention's encryption apparatus includes an image input unit 21, a security code input unit 22, a central processing unit 23, an image storing unit 24, an image print unit 25 and an image display unit 26.

The image input unit 21 receives and converts analog type information, e.g., an image or a text etc., into digital type, or reads the digital type information stored at a database. However, in this specification, only for easy description, only the analog type image is described as input information.

The security code input unit 22 receives a personal security code.

The central processing unit 23 performs a multi step encryption by decomposing the input information into a plurality of basic elements, puzzling the basic elements using random number maps, changing positions and colors of the basic elements irregularly based on one-color gray scale map.

The image storing unit 24 stores the image inputted through the image input unit 21, as an original image, and the encrypted image encrypted in the central processing unit 23.

The image print unit 25 prints the encrypted image encrypted in the central processing unit 23 on a printing, e.g., an identification card, money, bankbook, card etc.

The image display unit 26 displays, on a screen, the encrypted image.

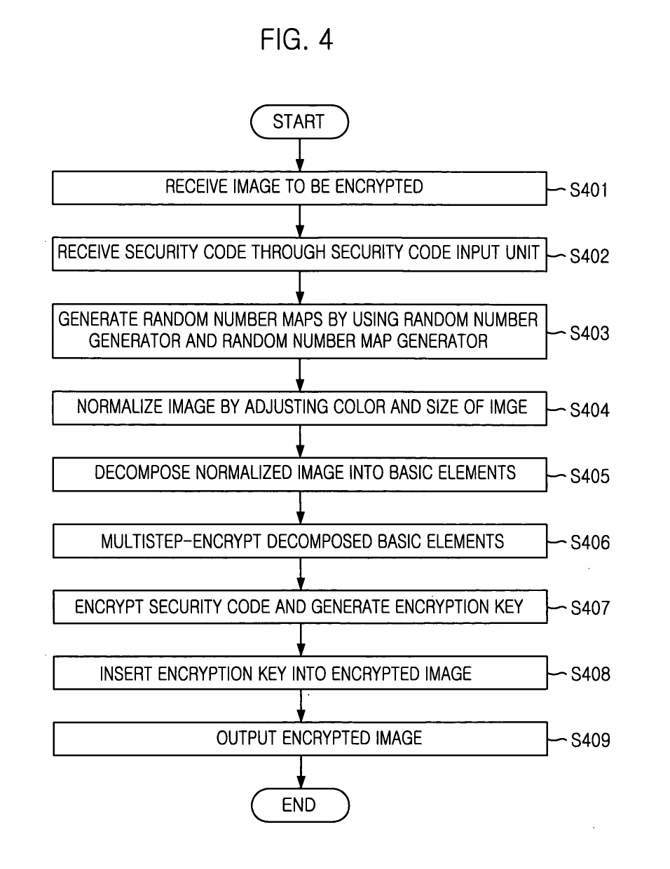

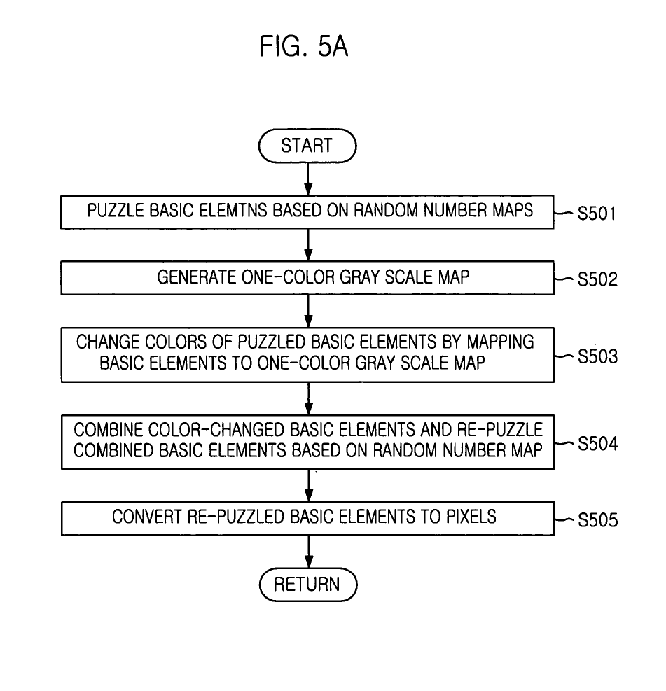

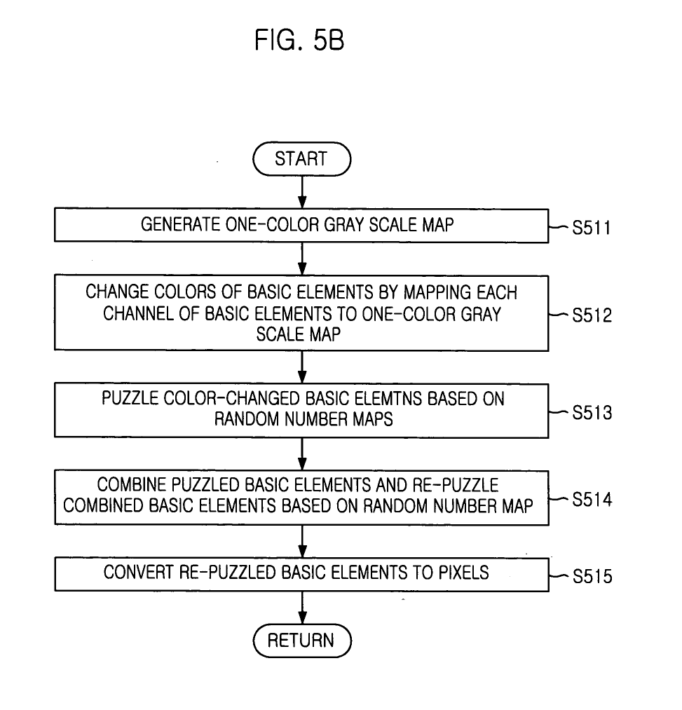

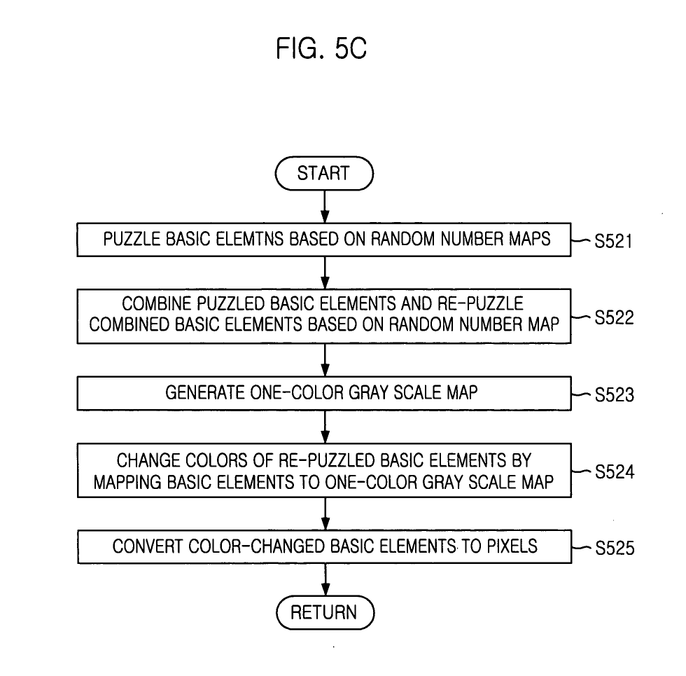

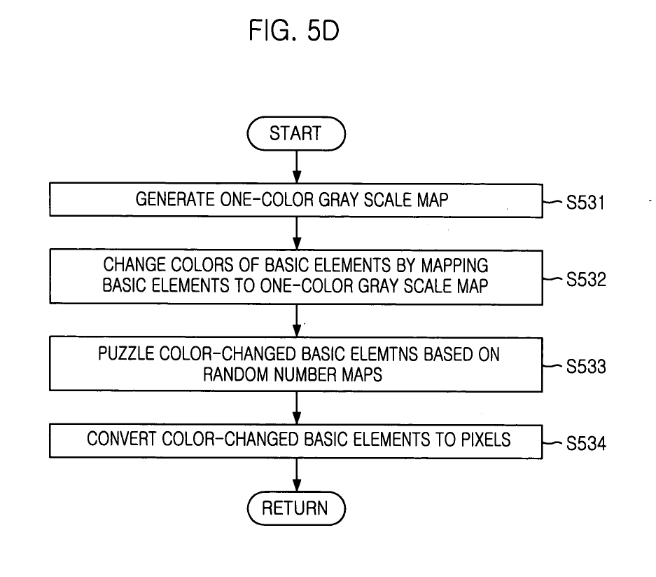

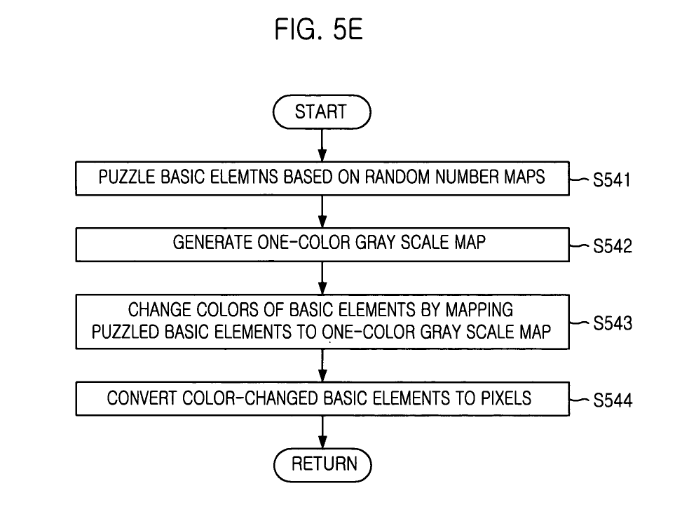

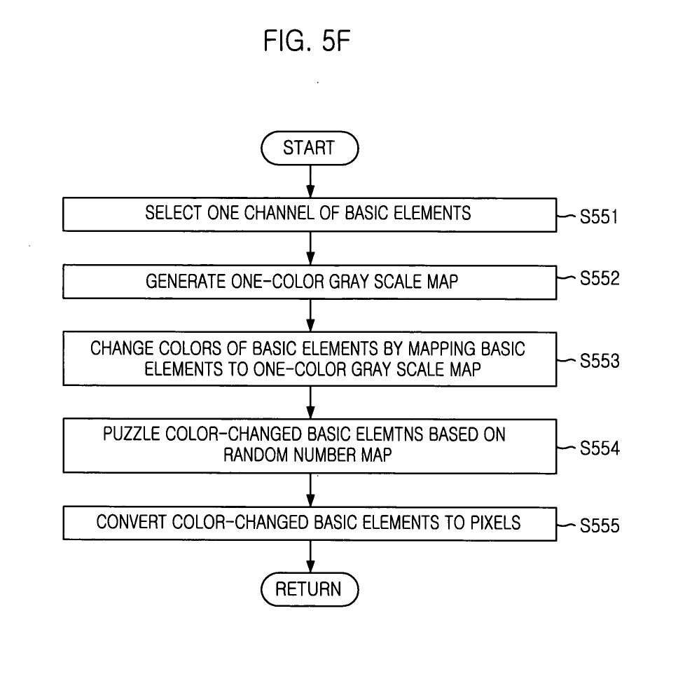

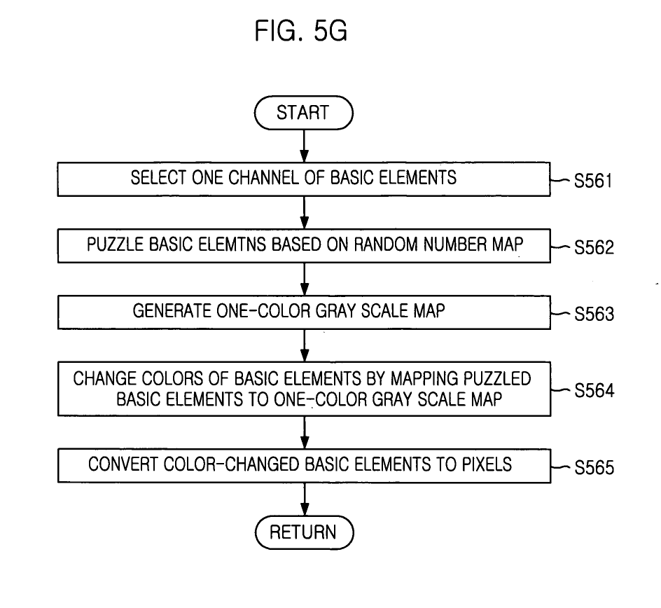

Here, the encryption apparatus may further include a communication unit (not shown in the drawing) for transmitting the encrypted image to an exclusive decrypting apparatus through a communication network. The central processing unit 23 is a block executing the invention's encryption method, and its detailed operational description will be provided later, referring to FIGS. 4 and 5.

The above-mentioned image print unit 25, the image display unit 26 and the communication unit (not shown in the drawing) are the components for outputting the encrypted image. Among them, the image display unit 26 and the communication unit are not essential components, but additional ones.

In case that the above encryption apparatus and method are used, the decrypting is impossible without the above mentioned exclusive decrypting apparatus. Especially, since in the encrypted image, the color and position of the basic element are changed in encrypting procedures, an inverse-estimation is impossible because of the characteristic of the computer in which definite numerical values should be compared.

On the other hand, the exclusive decrypting apparatus can minimize the time to determine forgery and maximize the recognition rate reading the encrypted image through the image input unit, and then, restoring it to the original image according to the decryption algorithm. That is, even though the encrypted image is partially damaged, the recognition rate is maximized by a correction and a restoration of the rest portion. Further, the exclusive decrypting apparatus can be embodied for stationary usage and small sized portable usage.

FIG. 3 is a block diagram of a decryption apparatus on a basic element by basic element basis in accordance with the present invention.

Referring to FIG. 3, this invention's decryption apparatus includes an image input unit 31, a security code input unit 32, a central processing unit 33, an image storing unit 34 and an image display unit 35.

The image input unit 31 reads the printed encrypted image, or reads digital type encrypted information stored at a database.

The security code input unit 32 receives a personal security code.

The central processing unit 33 performs inverse-puzzling basic elements of the encrypted image using a random number map, performing a multi step decryption by changing the position and the color of the basic element to the original state based on the gray scale map, and restoring the original image by converting the basic elements to the pixels.

The image storing unit 34 stores the encrypted image and the decrypted image.

The image display unit 35 displays the decrypted image being able to determine whether there is forgery or not.

Here, the image displaying unit 35 can be embodied so as to display the original image together with the decrypted image.

Here, the decryption apparatus may further include a communication unit (not shown in the drawing) for receiving the encrypted image from the encryption apparatus through a communication network. The central processing unit 33 is a block executing this invention's decryption method, to decrypt the encrypted image in real time, and may further execute the function of comparing the original image stored at the database with the decrypted image, being able to determine whether there is forgery or not. Also, it can be equipped with a result-displaying unit (not shown in the drawing) displaying the result for the existence and non-existence of the forgery, and it can be also displayed as a part of the image displaying unit 35. Further, in case that the central processing unit 33 extracts the encryption key from the encrypted image and then decrypts the encryption key to decrypt the security code, the present invention can be operated without the security code input unit 32 in the invention.

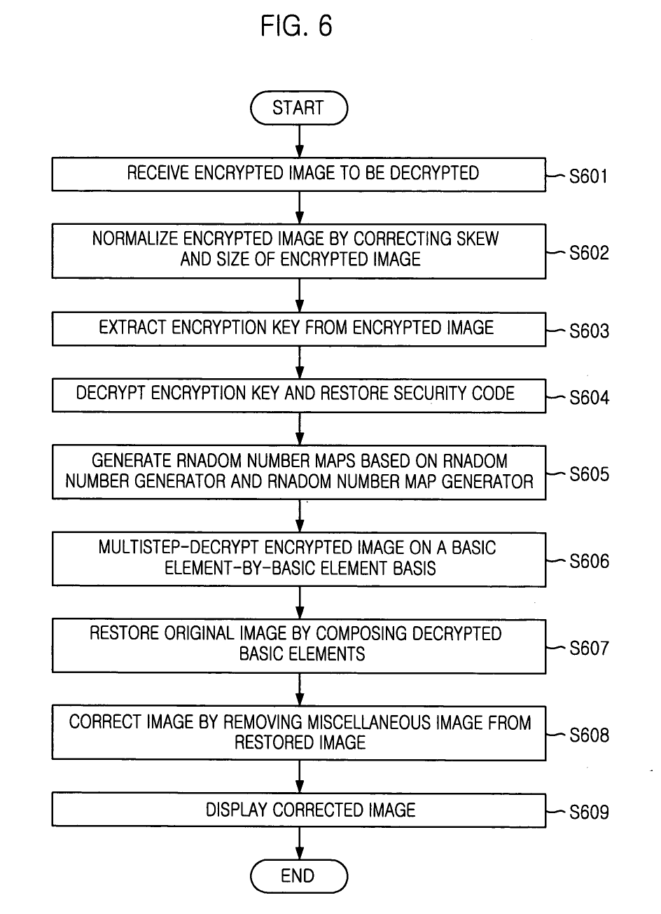

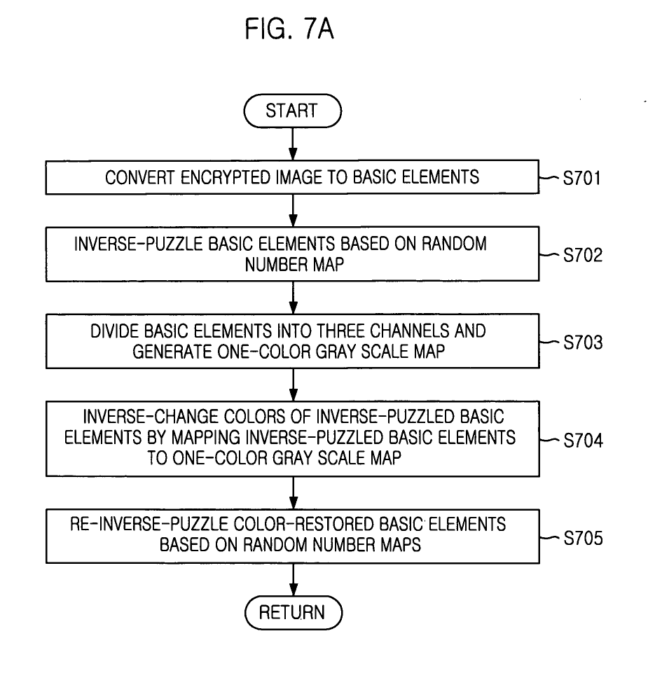

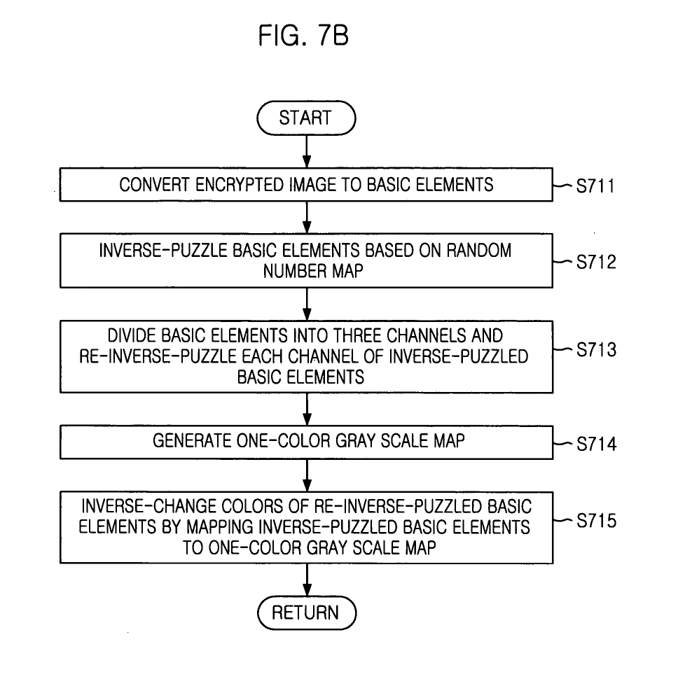

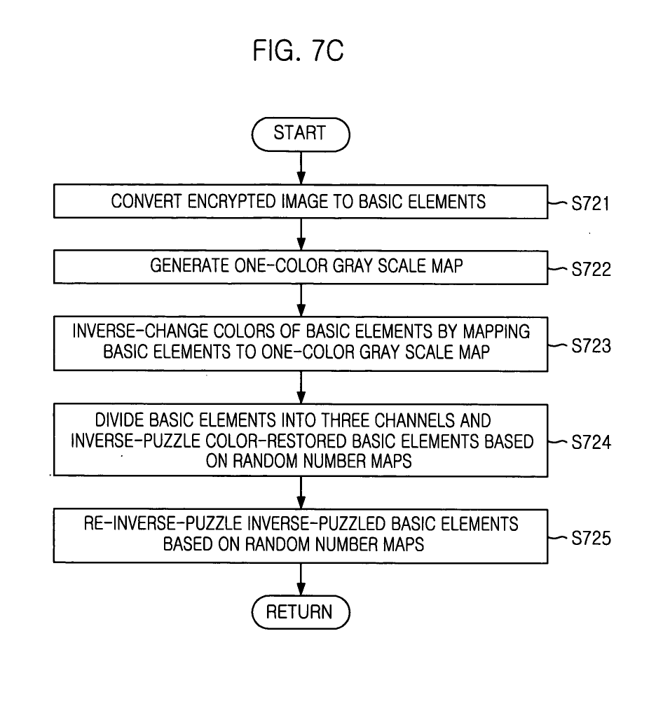

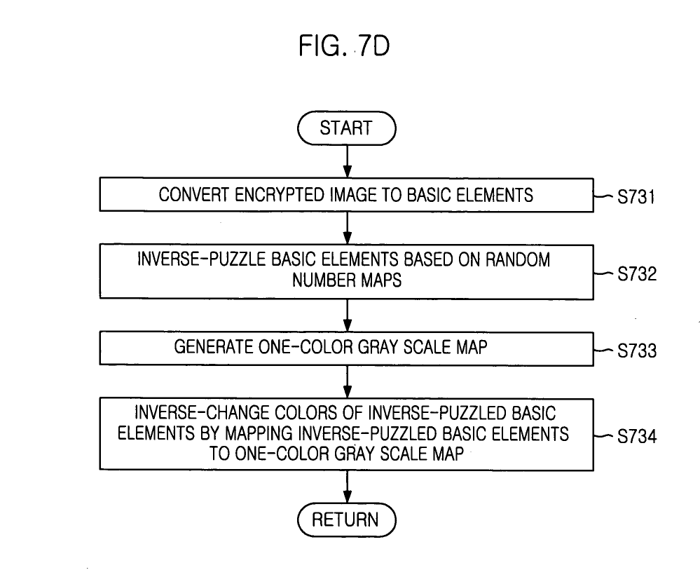

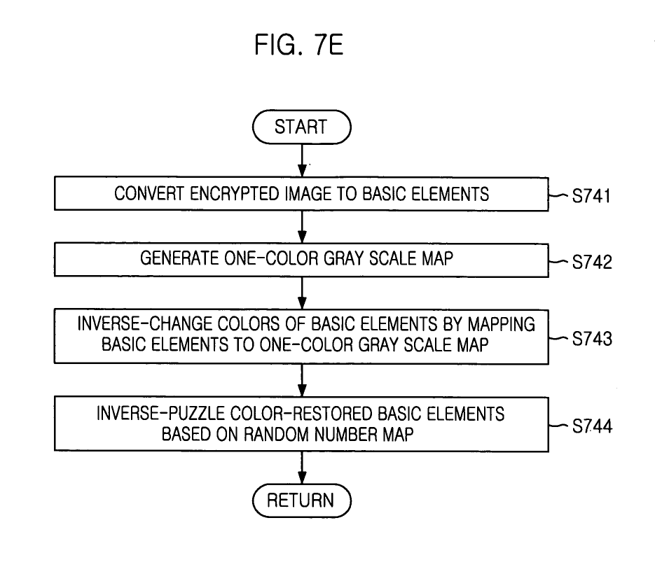

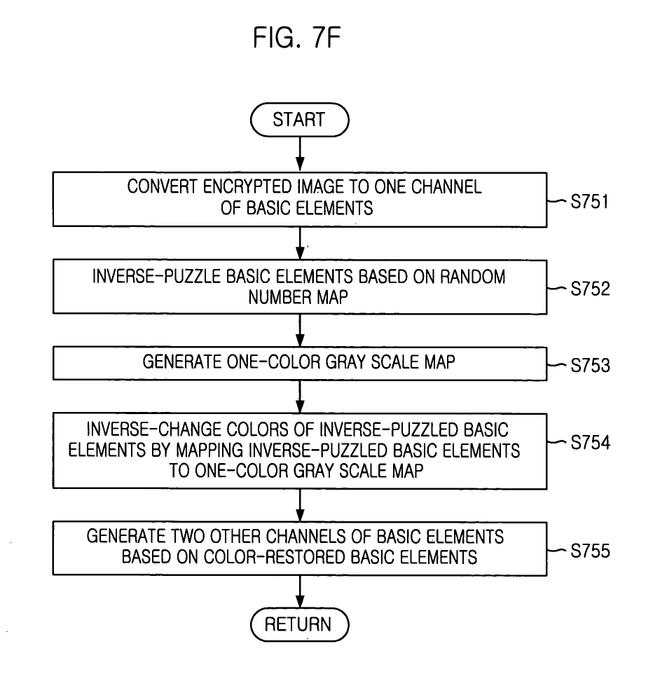

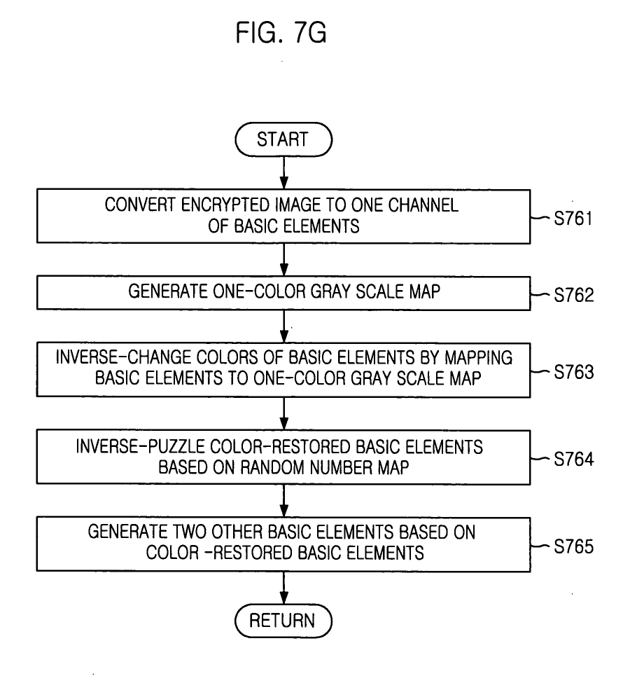

Additional detailed description will be provided later in reference to FIGS. 6 and 7.

Also, the image input unit 31 and the communication unit (not shown in the drawing) are the components for the input of the encrypted image. Among them, the communication unit is not an essential component of this invention, but an additional one.

FIG. 4 is an overall flowchart illustrating an encryption method in the present invention.

In the following description for the encryption method, which were explained in detail referring to FIGS. 1A to 1N will be simplified in this description.

First, input of information is done through the image input unit at step S401. As mentioned above, the input information includes an image, a text, etc., however, for only easy description, only the image is described in this specification as input information. The image input unit receives and converts the analog (original image or text etc.) into digital, or reads the digital image from the database.

A security code is inputted through the security code input unit at step S402.

After that, random number maps are generated using a random number generator only or a random number generator with a random number map generator at step S403. At this time, the random number generator can use various algorithms, such as data encryption standard (DES), SEED, etc.

Normalization process is performed by adjusting a color and a size of the image at step S404. In case of receiving digital image, the normalization procedure does not influence much upon the encryption procedure.

In the above procedures, either the image input step (S401), or the security code input step (S402), can be executed first. Also, the random number map generating step (S403) and the normalization step (S404) can be changed in its executing order. However, the information input step (S401) should be prior to the normalization step (S404), and the security code input step (S402) should be prior to the random number map generating step (S403), for a smooth operation.

After that, the normalized image is decomposed into a plurality of basic elements in step S405. Decomposing into a plurality of basic elements can be done using a variety of methods already introduced.

Then, the decomposed basic elements go through a multi step encryption in step S406. In the multi step encryption step (S406), the decomposed basic elements are multi step encrypted based on the random number maps and the one-color gray scale map. Its detailed operation of the multi step encryption will be described later in reference to FIGS. 5A to 5G.

After that, the security code is encrypted to generate an encryption key in step S407, and the encryption key is inserted into the encrypted image in step S408. In this invention's encryption method, the encryption key generating and inserting steps (S407, S408) are additional factors, and do not have to be performed in the encryption procedure. According to that, in a decryption method to be described later, the encryption key is extracted from the encrypted image, then the encryption key is decrypted to restore for the use of the security code, or the security code is received directly and used in the decryption procedure.

The encrypted image is outputted in step S409. At this time, an output system can adopt different methods such as printing on a printing material, storing at a record medium, and transmitting to a decrypting apparatus through a communication network. Particularly, among the above output methods printing the encrypted image on a paper of same color background can conceal the encrypted image into the background image. Also it is possible to print specific information on the encrypted image. Then, though the additional specific information may act as little noise in the decryption procedure, it does not influence upon the decryption of the image so much since the noise is eliminated in the correction procedure.

FIGS. 5A to 5G are flowcharts for illustrating embodiments of the multi step encryption step S406 based on basic element by basic element basis in FIG. 4.

A first embodiment shown in FIG. 5A is described as follows.

Primary encryption is performed puzzling each channel of the decomposed basic elements using a random number map in step S501. A one-color gray scale map is generated at step S502, and then, a secondary encryption is performed changing colors of the puzzled basic elements irregularly by mapping the puzzled basic elements to the one-color gray scale map at step S503. Here, a two-color or a multi-color gray scale map can be used instead of the one-color gray scale map as mentioned above.

After combining the multiple channels of the color-changed basic elements, a third encryption is performed re-puzzling the combined basic elements based on the random number map at step S504. Here, the combining procedure means a procedure of connecting the basic elements as illustrated in FIG. 1K, the order is not subject matter of the invention.

The re-puzzled basic elements are converted into pixels at step S505. At this time, the procedure of converting the re-puzzled basic elements is not an essential component, but an additional one. When using the procedure of converting the re-puzzled basic elements, the volume of the data in the post-encryption can be reduced one third (⅓).

Other embodiments are modification of the embodiment described above with reference to FIG. 5A, and there, for easy description, only differences between the other embodiments and the first embodiment as mentioned above will be described and the identical description will be skipped.

Referring to FIG. 5B, a one-color gray scale map is generated at step S511, and then, a primary encryption is performed changing the color of the basic elements irregularly by mapping the basic elements to the one-color gray scale map at step S512. The color-changed basic elements are puzzled based on the random number map at step S513. After combining the multiple channels of the puzzled basic elements, the combined basic elements are re-puzzled based on the random number map at step S514. The re-puzzled basic elements are converted into pixels at step S515.

Referring to FIG. 5C, another embodiment of the multi-step encryption will be described.

Primary encryption is performed puzzling the decomposed basic elements based on random number maps in step S521. After combining the puzzled basic elements, a second encryption is performed re-puzzling the combined basic elements based on the random number map at step S522. A one-color gray scale map is generated at step S523, and then, a third encryption is performed changing the color of the re-puzzled basic elements irregularly by mapping the re-puzzled basic elements to the one-color gray scale map at step S524. The color-changed basic elements are converted into pixels at step S525.

Referring to FIG. 5D, another embodiment of the multi-step encryption will be described.

A one-color gray scale map is generated at step S531, a primary encryption is performed changing the colors of the basic elements irregularly by mapping the basic elements to the one-color gray scale map at step S532. A secondary encryption is performed puzzling the color-changed basic elements based on the random number maps at step S533.

Then, the puzzled basic elements are converted into pixels at step S534.

Referring to FIG. 5E, another embodiment of the multi-step encryption will be described.

A primary encryption is performed puzzling the basic elements based on the random number maps at step S541.

A one-color gray scale map is generated at step S542, a secondary encryption is performed changing the colors of the puzzled basic elements irregularly by mapping the puzzled basic elements to the one-color gray scale map at step S543.

Then, the color-changed basic elements are converted into pixels at step S544.

Referring to FIG. 5F, another embodiment of the multi-step encryption will be described.

One channel of the decomposed basic elements is selected at step S551. At this time, since values of the basic elements are identical, any one channel can be selected.

A one-color gray scale map is generated at step S552, a primary encryption is performed changing the color of the basic element irregularly by mapping the basic element to the one-color gray scale map at step S553. A secondary encryption is performed puzzling the color-changed basic elements based on the random number maps at step S554. Then, the puzzled basic elements are converted into pixels at step S555. At this time, the other two basic elements corresponding to one element are generated as dummy data. For example, there is the R channel of the basic element which is encrypted, G and B channels of basic elements are additionally generated, and then, the R, G and B channels of the basic elements converted to a pixel.

Referring to FIG. 5G, another embodiment of the multi-step encryption will be described.

One channel of the decomposed basic elements is selected at step S561. As mentioned above, since values of the basic elements are identical, any one channel can be selected.

A primary encryption is performed puzzling the selected channel of the basic elements based on the random number maps at step S562.

A one-color gray scale map is generated at step S563, a secondary encryption is performed changing the colors of the puzzled basic elements irregularly by mapping the puzzled basic elements to the one-color gray scale map at step S564. Then, the color-changed basic elements are converted into pixels at step S565. At this time, the other two basic elements corresponding to one element are generated as dummy data. For example, there is the R channel of the basic element which is encrypted, G and B channels of basic elements are additionally generated, and then, the R, G and B channels of the basic elements converted to a pixel.

FIG. 6 is a flowchart illustrating a decryption method on a basic element by basic element basis in accordance with the present invention.

The following decryption procedure will be explained on the basis of a technical gist as its concerned parts can be well known by those skilled in the field referring to process operations of respective procedures, which were described in detail in the encryption method.

First, the encrypted image is inputted through the image input unit in step S601. At this time, the image input unit reads the printed encrypted image in digital type; or receives the digital type encrypted image stored at a database. The encrypted image may be transferred and inputted from the encryption apparatus through a communication network instead of the image input unit.

Subsequently, the normalization of the inputted encrypted image is performed through skew correction and size correction in step S602. In case of receiving digital image, the omission of such normalization step S602 does not influence much upon the decryption procedure.

Then, the encryption key is extracted from the encrypted image at step S603, and then, decrypted to restore the security code at step S604. Meantime, in case of embodying the invention so as to directly receive the security code through the security code input unit of the decryption apparatus instead of inserting it into the encrypted image by generating the encryption key in the encryption procedure, the encryption key extraction and security code restoration procedures S603, S604 do not need to be performed.

Herewith, either the encrypted image input step S601 or the security code input step can be executed first, and the normalization step S602 can be executed at any time after the encrypted image input and before the multi step decryption.

Then, the random number maps are generated using a random number generator only or by a random number generator with a random number map generator at step S605.

After that, the encrypted image is multi step-decrypted on a basic element by basic element basis at step S606. In the multi step decryption step S606, the basic elements of the encrypted image are decrypted based on the random number maps and the one-color gray scale map, and its detailed operation will be later described referring to FIGS. 7A to 7G.

The original image is restored combining the decrypted basic elements in step S607, and this is an inverse operation of the decomposition step S405 in the encryption method.

Then, a miscellaneous image is removed from the restored image to correct the image in step S608. In case that the miscellaneous image exists in the decrypted image, a primary correcting procedure is performed using a spatial filtering technique which uses information of a neighboring pixel and has an optimum similarity, and in case that all of neighboring pixels are part of the miscellaneous image, a secondary correcting procedure can be computed from a restoration value of the neighboring pixel of the neighborhood. The correcting step S608 is not an essential component, but an additional procedure for improving the quality of the decrypted image.

Then, the corrected image is displayed to determine whether it is forged or not in step S609.

Meanwhile, in the decryption method and before the displaying step S609, it can perform a procedure where the original image stored at the database is compared with the restored image to determine the possibility of forgery, and display the result. Further, before the displaying step S609, it can perform a procedure where the digitized information of the information overlapped on the encrypted image is compared with the restored information to determine the possibility of forgery and display the result. Furthermore, before the displaying step S609, it can perform a procedure where the digitized information of the printed information on the encrypted image is compared with the restored information, to determine the possibility of forgery and display the result.

FIGS. 7A to 7G are flowcharts illustrating embodiments of the multi step decryption (step S606) in FIG. 6, which processes the encrypted image on a basic element by basic element basis.

First, referring FIG. 7A, an embodiment of the multi-step decryption is described as follows.

The encrypted image is decomposed into basic elements at step S701. If the encrypted image is represented by the basic elements, the procedure S701 of decomposing is not performed.

Primary decryption is performed inverse-puzzling the decomposed encrypted image using the random number map at step S702. After dividing the inverse-puzzled basic elements into multiple channels, a one-color gray scale map is generated at step S703, and then, a secondary decryption is performed by inverse-mapping the inverse-puzzled basic elements to the one-color gray scale map, thereby restoring the color of the basic elements at step S704. At this time, since the one-color gray scale map is used in the encryption, the one-color gray scale map is used in the decryption. However, if the two-color or multi-color gray scale map is used in the encryption, the two-color or multi-color gray scale map is used.

Third decryption is performed re-inverse-puzzling the color-restored basic elements based on the random number maps at step S705.

Other embodiments are modification of the embodiment described above with reference to FIG. 5A, and there, for easy description, only differences between the other embodiments and the first embodiment as mentioned above will be described and the identical description will be skipped.

Referring to FIG. 7B, another embodiment of the multi-step decryption of which an operational order of the embodiment shown in FIG. 7A, is changed as follows.

The encrypted image is decomposed into basic elements at step S711.

Primary decryption is performed inverse-puzzling the decomposed encrypted image based on the random number map at step S712. After dividing the inverse-puzzled basic elements into multiple channels, a secondary decryption is performed re-inverse-puzzling the inverse-puzzled basic elements based on the random number maps at step S713.

A one-color gray scale map is generated at step S714, and then, a third decryption is performed by inverse-mapping the re-inverse-puzzled basic elements to the one-color gray scale map, thereby restoring the color of the basic elements at step S715.

Referring to FIG. 7C, another embodiment of the multi-step decryption will be described.

The encrypted image is decomposed into basic elements at step S721.

A one-color gray scale map is generated at step S722, and then, a primary decryption is performed by inverse-mapping the decomposed basic elements to the one-color gray scale map, thereby restoring the colors of the basic elements at step S723.

After dividing the Secondary decryption is performed inverse-puzzling the color-restored basic elements based on the random number map at step S724. Third decryption is performed re-inverse-puzzling the inverse-puzzled basic elements based on the random number maps at step S725.

Referring to FIG. 7D, another embodiment of the multi-step decryption will be described.

The encrypted image is decomposed into basic elements at step S731.

A primary decryption is performed inverse-puzzling the decomposed encrypted image based on the random number map at step S732.

A one-color gray scale map is generated at step S733, and then, a secondary decryption is performed by inverse-mapping the inverse-puzzled basic elements to the one-color gray scale map, thereby restoring the colors of the basic elements at step S734.

Referring to FIG. 7E, another embodiment of the multi-step decryption will be described.

The encrypted image is decomposed into basic elements at step S741.

A one-color gray scale map is generated at step S742, and then, a primary decryption is performed by inverse-mapping the decomposed basic elements to the one-color gray scale map, thereby restoring the colors of the basic elements at step S743.

Secondary decryption is performed inverse-puzzling the color-restored basic elements based on the random number maps at step S744.

Referring to FIG. 7F, another embodiment of the multi-step decryption will be described.

The encrypted image is decomposed into one channel of basic elements at step S751.

A primary decryption is performed inverse-puzzling the basic elements based on the random number map at step S752.

A one-color gray scale map is generated at step S753, and then, a secondary decryption is performed by inverse-mapping the inverse-puzzled basic element to the one-color gray scale map, thereby restoring the colors of the basic elements at step S754.

Based on the color-restored basic elements, two basic elements are generated at step S755.

Referring to FIG. 7G, another embodiment of the multi-step decryption will be described.

The encrypted image is decomposed into one channel of basic elements at step S761.

A one-color gray scale map is generated at step S762, and then, a primary decryption is performed inverse-mapping the decomposed basic element to the one-color gray scale map, thereby restoring the colors of the basic elements at step S763.

A secondary decryption is performed inverse-puzzling the decomposed encrypted image using the random number map at step S764.

Based on the inversed-puzzled basic elements, two other channels of basic elements are generated at step S765.

As stated above this invention strengthens more the security and stability provided in a security system (particularly printed image security system), what is more it can obtain a concealment effect of the encrypted image as an optical illusion effect when the encrypted image is printed on the same color as the background.

In addition, this invention can be applied to various fields, e.g., identification documents (passport, identification card, driver's license, student identification card, public official identification card, medical insurance card etc.), paper money, bill, securities, gift certificate, membership card, and various certificates issued by government and municipal offices (certificate of a seal impression, register certified copy etc.), a card (credit card etc.), a bankbook, etc.

Also, in the present invention, the encryption/decryption apparatus and method can be embodied interlocking the encryption apparatus and method and the decryption apparatus and method each other. As this can be embodied by those skilled in the field, more detailed description will be omitted hereby.

This invention's method as above-mentioned, can be embodied as a program and can be stored at a computer readable recording medium, the record medium being a CD-ROM, a RAM, a ROM, a floppy disk, a hard disk, an optical magnetic disk, etc.

The present invention can be high security-encrypted so as to become almost impossible the decoding without an exclusive decrypting apparatus, by performing a multi step encryption of information (image, text, etc.) on a pixel by pixel basis according to a random number algorithm and an encryption algorithm.

Additionally, in this invention, an encrypted image is printed in the same color as the background color, to thereby heighten a concealment effect, that is, other person can not know where the encryption is.

Further, the time taken in determining the possibility of forgery can be minimized, and the encrypted image can be restored in real time.

In addition, a recognition rate can be maximized even though the encrypted image is partially damaged, using a multi-stage image process technique on the rest portion so as to perform a correction and a restoration. This way a stabilized restoration can be provided. Also, the exclusive decrypting apparatus can be embodied for stationary usage and a small sized portable usage.

It will be apparent to those skilled in the field that substitution, modifications and variations can be made in the present invention without deviating from the spirit or scope of the invention. Thus, it is intended that the present invention cover the modifications and variations of this invention provided they come within the scope of the appended claims and their equivalents.

What is claimed is:

1. A method for encrypting information on a basic element-by-basic element basis, comprising the steps of:
a) receiving information to be encrypted;
b) generating random number maps;
c) decomposing the information into a plurality of basic elements which are classified into multiple channels;
d) encrypting the basic elements and generating encrypted information; and
e) outputting the encrypted information.

2. The method as recited in claim 1, wherein said step d) performs a multi step encryption including a position converting procedure which changes positions of the basic elements and a color converting procedure which changes colors of the basic elements based on the random number maps.

3. The method as recited in claim 2, wherein said step d) includes the steps of:
d1) primary encryption puzzling the basic elements based on the random number maps and generating puzzled basic elements;
d2) secondary encryption generating a one-color gray scale map, mapping the puzzled basic elements to the gray scale map and generating color-changed basic elements; and
d3) third encryption combining the multiple channels of the color-changed basic elements and re-puzzling the color-changed basic elements based on the random number map.

4. The method as recited in claim 2, wherein said step d) includes the steps of:
d1) primary encryption generating a gray scale map, mapping the basic elements to the one-color gray scale map and generating color-changed basic elements;
d2) secondary encryption puzzling the color-changed basic elements based on the random number maps and generating puzzled basic elements; and
d3) third encryption combining the multiple channels of the color-changed basic elements and re-puzzling the combined basic elements based on the random number map.

5. The method as recited in claim 2, wherein said step d) includes the steps of:
d1) primary encryption puzzling the basic elements based on the random number maps and generating puzzled basic elements;
d2) secondary encryption combining the multiple channels of the puzzled basic elements and re-puzzling the puzzled basic element based on the random number map and generating re-puzzled basic elements; and
d3) third encryption generating a gray scale map, mapping the re-puzzled basic element to the gray scale map and generating color-changed basic elements.

6. The method as recited in claim 2, wherein said step d) includes the steps of:
d1) primary encryption generating a one-color gray scale map, mapping the basic elements to the gray scale map and generating color-changed basic elements; and
d2) secondary encryption puzzling the color-changed basic element based on the random number map and generating puzzled basic elements.

7. The method as recited in claim 2, wherein said step d) includes the steps of:
d1) primary encryption generating a gray scale map, mapping the basic elements to the gray scale map and generating color-changed basic elements; and
d2) secondary encryption puzzling the color-changed basic elements based on the random number maps and generating puzzled basic elements.

8. The method as recited in claim 2, wherein said step d) includes the steps of:
d1) primary encryption puzzling the basic elements using the random number maps and generating puzzled basic elements; and
d2) secondary encryption generating a one-color gray scale map, mapping the puzzled basic element to the gray scale map and generating color-changed basic elements.

9. The method as recited in claim 2, wherein said step d) includes the steps of:
d1) primary encryption puzzling the basic elements based on the random number maps and generating puzzled basic elements; and
d2) secondary encryption generating a one-color gray scale map, mapping the puzzled basic elements to the gray scale map and generating color-changed basic elements.

10. The method as recited in claim 2, wherein said step d) includes the steps of:
d1) selecting one channel of the basic elements;
d2) primary encryption generating a gray scale map, mapping the basic elements to the gray scale map and generating color-changed basic elements; and
d3) secondary encryption puzzling the color-changed basic elements based on the random number map and generating puzzled basic elements.

11. The method as recited in claim 2, wherein said step d) includes the step of:
d1) selecting one channel of the basic elements;
d2) primary encryption puzzling the basic elements based on the random number map and generating puzzled basic elements; and
d3) secondary encryption generating a one-color gray scale map, mapping the puzzled basic element to the gray scale map and generating color-changed basic elements.

12. The method as recited in one of claims 5, 8, 9 or 11 wherein the color-changed basic elements are converted to pixels.

13. The method as recited in one of claims 6, 7 or 10, wherein the puzzled basic elements are converted to pixels.

14. The method as recited in claims 3 or 4, wherein the puzzled basic elements are converted to pixels.

15. The method as recited in one of claims 2 to 11, wherein in the color converting procedure, the gray scale map is generated as the same color as a background of printings, to thereby print the encrypted information in the same color as the background color of the printing material.

16. The method as recited in any one of claims 2 to 11, wherein the gray scale map is a one-color gray scale map.

17. The method as recited in claim 5, wherein the gray scale map includes a yellow gray scale map.

18. The method as recited in any one of claims 2 to 11, wherein the gray scale map is a multi-color gray scale map.

19. The method as recited in claim 1, wherein said step d) includes the step of: changing positions of the basic elements based on the random number map.

20. The method as recited in claim 18, wherein said step d) includes the step of: changing positions of each channel of the basic elements based on the random number map.

21. The method as recited in any one of claims 1-11, 18 or 19, further including the step of: changing a color and a size of the information to be encrypted for normalization.

22. The method as recited in any one of claims 1-11, 18 or 19, further comprising the step of:
f) encrypting a security code and generating an encryption key; and
g) inserting the encryption key into the encrypted information.

23. The method as recited in any one of claims 1-11, 18 or 19, wherein said step a) includes the steps of:
a1) receiving the information to be encrypted, the information having an image or a text; and
a2) receiving a security code.

24. The method as recited in claim 23, wherein said step al) includes the step of converting the information to be encrypted from analog information to digital information.

25. The method as recited in claim 23, wherein said step a1) includes the step of reading digital information stored at a recording medium.

26. The method as recited in any one of claims 1-11, 18 or 19, wherein the random number map is generated by using only a random number generator.

27. The method as recited any one of claims 1-11, 18 or 19, wherein the random number map is generated by using a random number generator and a random number map generator.

28. The method as recited in any one of claims 1-11, 18 or 19, wherein said step e) includes the step of printing the encrypted information on printing.

29. The method as recited in claim 28, wherein the printing includes identification documents (e.g., passport, identification card, driver's license, student identification card, public official identification card, medical insurance card etc.); paper money, bill, securities, gift certificate, membership card, and various certificates issued by government and municipal offices (e.g., certificate of a seal impression, register certified copy etc.); a card (credit card etc.); and a bankbook.

30. The method as recited in claim 28, wherein said step e) further includes the step of printing particular information on the printings on which the encrypted information is printed.

31. The method as recited in claim 18, wherein said step e) further includes the step of displaying the encrypted information on a display unit.

32. The method as recited in any one of claims 1-11, 18, or 19, wherein said step e) includes the step of: transmitting the encrypted information to an external device.

33. The method as recited in any one of claims 1-11, 18, or 19, wherein said step e) includes the step of storing the encrypted information at a record medium.

34. A method for decrypting information on a basic element-by-basic element basis, comprising the steps of:
a) receiving encrypted information;
b) obtaining a security code used for decrypting the encrypted information;
c) generating random number maps;
d) decrypting the encrypted information on a basic element by basic element basis and generating decrypted basic elements;
e) composing the decrypted basic elements and generating restored information; and
f) outputting the restored information.

35. The method as recited in claim 24, wherein said step d) performs a multi step decryption including a position converting procedure which inverse-changes positions of the basic elements of the encrypted information based on the random number map and a color converting procedure which inverse-changes colors of the basic elements of the encrypted information based on a gray scale map.

36. The method as recited in claim 35, wherein said step d) includes the steps of:
d1) primary decryption decomposing the encrypted information into a plurality of basic elements and inverse-puzzling the basic elements based on the random number map, and generating inverse-puzzled basic elements;
d2) secondary decryption dividing the inverse-puzzled basic elements into multiple channels, generating a gray scale map, mapping the inverse-puzzled basic elements to the gray scale map and generating color-restored basic elements; and
d3) third decryption re-inverse-puzzling the color-restored basic elements based on the random number maps and generating re-inverse-puzzled basic elements.

37. The method as recited in claim 35, wherein said step d) includes the steps of:
d1) primary decryption decomposing the encrypted information into a plurality of basic elements and inverse-puzzling the basic elements based on the random number map, and generating inverse-puzzled basic elements;
d2) secondary decryption dividing the inverse-puzzled basic elements into multiple channels, re-inverse-puzzling each channel of the inverse-puzzled basic elements based on the random number map and generating an re-inverse-puzzled basic elements; and
d3) third decryption generating a gray scale map, mapping the re-inverse-puzzled basic elements to the gray scale map and generating color-restored basic elements.

38. The method as recited in claim 35, wherein said step d) includes the steps of:
d1) primary decryption decomposing the encrypted information into a plurality of basic elements, generating a gray scale map, mapping the basic elements to the gray scale map and generating color-restored basic elements;
d2) secondary decryption inverse-puzzling the color-restored basic elements based on the random number map and generating inverse-puzzled basic elements; and
d3) third decryption dividing the inverse-puzzled basic elements into multiple channels, re-inverse-puzzling each channel of the inverse-puzzled basic elements based on the random number map and generating re-inverse-puzzled basic elements.

39. The method as recited in claim 35, wherein said step d) includes the steps of:
d1) primary decryption inverse-puzzling the basic elements based on the random number map and generating inverse-puzzled basic elements; and
d2) secondary decryption generating a gray scale map, mapping the inverse-puzzled basic elements to the gray scale map and generating color-restored basic elements.

40. The method as recited in claim 35, wherein said step d) includes the steps of:
d1) primary decryption decomposing the encrypted information to a plurality of basic elements and inverse-puzzling the basic elements based on the random number map and generating inverse-puzzled basic elements; and
d2) secondary decryption generating a gray scale map, mapping the inverse-puzzled basic elements to the gray scale map and generating color-restored basic elements.

41. The method as recited in claim 35, wherein said step d) includes the steps of:
d1) primary decryption generating a gray scale map, mapping the basic elements to the gray scale map and generating color-restored basic elements; and
d2) secondary decryption inverse-puzzling the color-restored basic elements based on the random number maps and generating inverse-puzzled basic elements.

42. The method as recited in claim 35, wherein said step d) includes the steps of:
d1) primary decryption decomposing the encrypted information into a plurality of basic elements and generating a gray scale map, mapping the basic elements to the gray scale map and generating color-restored basic elements; and
d2) primary decryption inverse-puzzling the color-restored basic elements based on the random number maps and generating inverse-puzzled basic elements.

43. The method as recited in claim 35, wherein said step d) includes the steps of:
d1) primary decryption inverse-puzzling one channel of the basic elements based on the random number map and generating inverse-puzzled basic elements;
d2) secondary decryption generating a gray scale map, mapping the inverse-puzzled basic elements to the gray scale map and generating color-restored basic elements; and
d3) generating the other channels of basic elements based on the color-restored basic elements.

44. The method as recited in claim 35, wherein said step d) includes the steps of:
d1) primary decryption generating a gray scale map, mapping the basic elements to the gray scale map and generating color-restored basic elements;
d2) primary decryption inverse-puzzling the color-restored basic elements based on the random number map and generating inverse-puzzled basic elements; and
d3) generating the other channels of basic elements based on the inverse-puzzled basic elements.

45. The method as recited in claim 43 or 44, wherein said step d) further includes the step of d4) converting pixels of the encrypted information to one channel of basic elements.

46. The method as recited in any one of claims 36 to 42, wherein said step d) further includes the step of d4) converting pixels of the encrypted information to basic elements.

47. The method as recited in any one of claims 35 to 44, wherein the gray scale map is a one-color gray scale map.

48. The method as recited in claim 47, wherein the gray scale map includes a yellow gray scale map.

49. The method as recited in any one of claims 35 to 44, wherein the gray scale map is a multi-color gray scale map.

50. The method as recited in claim 28, wherein said step d) includes the step of performing a decryption by inverse-puzzling positions of the basic elements based on the random number map.

51. The method as recited in claim 28, wherein said step d) includes the step of performing a decryption by inverse-puzzling positions of the basic elements based on the random number map.

52. The method as recited in any one of claims 34-44, 50 or 51, further comprising the step: g) correcting a skew and a size of the encrypted information for normalization.

53. The method as recited in any one of claims 34 to 44, 50 or 51, further comprising the step: g) performing correction of the restored information by eliminating miscellaneous image from the restored information.

54. The method as recited in claim 53, wherein said step g) includes the steps of:
g1) performing a primary restoration by utilizing a spatial filtering technique having an optimum similarity in which information of neighboring pixel is used, in case there is a miscellaneous image on the restored information; and
g2) performing a secondary restoration executing an inverse-estimation and restoration using a restored value of the neighboring pixel of the neighborhood in case that all the neighboring pixels are part of the miscellaneous image.

55. The method as recited in any one of claims 34 to 44, 50 or 51, further comprising the step: h) comparing the original information stored in a database with the restored information, determining whether there is forgery or not, and displaying its result.

56. The method as recited in any one of claims 34 to 44, 50 or 51, further comprising the step: h) comparing the digitized additional information printed on the encrypted information, with the restored information, and determining whether there is forgery or not, and displaying its result.

57. The method as recited in any one of claims 34 to 44, 50 or 51, further comprising the step: h) comparing the digitized information from other information on the printing, with the restored information, determining whether there is forgery or not, and displaying its result.

58. The method as recited in any one of claims 34 to 44, 50 or 51, further comprising the step: h) outputting the restored information together with the original information.

59. The method as recited in any one of claims 34 to 44, 50 or 51, wherein said step a) includes the step of reading the encrypted information printed on a printing in digital type.

60. The method as recited in claim 59, wherein the printing includes identification documents (e.g., passport, identification card, driver's license, student identification card, public official identification card, medical insurance card etc.); paper money, bill, securities, gift certificate, membership card, and various certificates issued by government and municipal offices (certificate of a seal impression, register certified copy etc.); a card (credit card etc.); and a bankbook.

61. The method as recited in any one of claims 34 to 44, 50 or 51, wherein said step a) includes the step of reading the encrypted information, which is digital information stored in a record medium.

62. The method as recited in any one of claims 34 to 44, 50 or 51, wherein said step a) includes the step of receiving the encrypted information from an encryption apparatus.

63. The method as recited in any one of claims 34 to 44, 50 or 51, wherein said step b) includes the steps of:
b1) extracting an encryption key from the encrypted information; and
b2) decrypting the encryption key and restoring the security code.

64. The method as recited in any one of claims 34 to 44, 50 or 51, wherein said step b) includes the step of receiving the security code through a security code obtaining means.

65. The method as recited in any one of claims 34 to 44, 50 or 51, wherein the random number map is generated by using only a random number generator.

66. The method as recited in any one of claims 34 to 44, 50 or 51, wherein the random number map is generated by using a random number generator and a random number map generator.

67. An apparatus for encrypting information on a basic element by basic element basis, comprising:
an input means for receiving information to be encrypted;
a security code obtaining means for obtaining a security code;
an encryption means for decomposing the information into multiple channels of basic elements and for encrypting the basic elements, thereby generating encrypted information;
a storing means for storing the encrypted information; and
an output means for outputting the encrypted information.

68. The apparatus as recited in claim 67, wherein said encryption means performs a multi step encryption in which positions of the basic elements are changed based on random number maps and positions of the basic elements based on gray scale map.

69. The apparatus as recited in claim 68, wherein said encryption means includes:
means for primary encryption puzzling the basic elements based on the random number maps and generating puzzled basic elements;
means for secondary encryption generating a gray scale map, mapping the puzzled basic elements to the gray scale map and generating color-changed basic elements; and
means for third encryption combining the multiple channels of the color-changed basic elements and re-puzzling the color-changed basic elements based on the random number map.

70. The apparatus as recited in claim 68, wherein said encryption means includes:
means for primary encryption generating a gray scale map, mapping the basic elements to the gray scale map and generating color-changed basic elements;
means for secondary encryption puzzling the color-changed basic elements based on the random number maps and generating puzzled basic elements; and
means for third encryption combining the multiple channels of the color-changed basic elements and re-puzzling the combined basic elements based on the random number map.

71. The apparatus as recited in claim 68, wherein said encryption means includes:
means for primary encryption puzzling the basic elements based on the random number maps and generating puzzled basic elements;
means for secondary encryption combining the multiple channels of the puzzled basic elements and re-puzzling the puzzled basic element based on the random number map and generating re-puzzled basic elements; and
means for third encryption generating a gray scale map, mapping the re-puzzled basic elements to the gray scale map and generating color-changed basic elements.

72. The apparatus as recited in claim 68, wherein said encryption means includes:
means for primary encryption generating a one-color gray scale map, mapping the basic elements to the gray scale map and generating color-changed basic elements; and
means for secondary encryption puzzling the color-changed basic element based on the random number map and generating puzzled basic elements.

73. The apparatus as recited in claim 68, wherein said encryption means includes:
means for primary encryption generating a gray scale map, mapping the basic elements to the gray scale map and generating color-changed basic elements; and
means for secondary encryption puzzling the color-changed basic elements based on the random number maps and generating puzzled basic elements.

74. The apparatus as recited in claim 68, wherein said encryption means includes:
means for primary encryption puzzling the basic elements using the random number maps and generating puzzled basic elements; and
means for secondary encryption generating a one-color gray scale map, mapping the puzzled basic elements to the gray scale map and generating color-changed basic elements.

75. The apparatus as recited in claim 68, wherein said encryption means includes:
means for primary encryption puzzling the basic elements based on the random number maps and generating puzzled basic elements; and
means for secondary encryption generating a one-color gray scale map, mapping the puzzled basic elements to the gray scale map and generating color-changed basic elements.

76. The apparatus as recited in claim 68, wherein said encryption means includes:
means for selecting one channel of the basic elements;
means for primary encryption generating a gray scale map, mapping the basic elements to the gray scale map and generating color-changed basic elements; and
means for secondary encryption puzzling the color-changed basic elements based on the random number map and generating a puzzled basic elements.

77. The apparatus as recited in claim 68, wherein said encryption means includes:
means for selecting one channel of the basic elements;
means for primary encryption puzzling the basic elements based on the random number map and generating puzzled basic elements; and
means for secondary encryption generating a one-color gray scale map, mapping the puzzled basic elements to the gray scale map and generating color-changed basic elements.

78. The apparatus as recited in one of claims 71, 74, 75 or 77, wherein the color-changed basic elements are converted to pixels.

79. The apparatus as recited in one of claims 72, 73 or 76, wherein the puzzled basic elements are converted to pixels.

80. The method as recited in claims 69 or 70, wherein the puzzled basic elements are converted to pixels.

81. The apparatus as recited in one of claims 68 to 77, wherein in the color converting procedure, the gray scale map is generated as the same color as a background of printings, to thereby print the encrypted information in the same color as the background color of the printing material.

82. The apparatus as recited in any one of claims 69 to 78, wherein the gray scale map is a one-color gray scale map.

83. The apparatus as recited in claim 82, wherein the gray scale map includes a yellow gray scale map.

84. The apparatus as recited in any one of claims 68 to 11, wherein the gray scale map is a multi-color gray scale map.

85. The apparatus as recited in claim 67, wherein said encryption means includes means for changing positions of the basic elements based on the random number map.

86. The apparatus as recited in claim 85, wherein said encryption means includes means for changing positions of each channel of the basic elements based on the random number map.

87. The apparatus as recited in any one of claims 67-77, 85 or 86, further includes means for changing a color and a size of the information to be encrypted for normalization.

88. The apparatus as recited in any one of claims 67-77, 85 or 86, said encryption means further includes:
means for encrypting a security code and generating an encryption key; and
means for inserting the encryption key into the encrypted information.

89. The apparatus as recited in any one of claims 67-77, 85 or 86, wherein said input means receives the information to be encrypted, the information having an image or a text, and converts the information from analog type to digital type.

90. The apparatus as recited in any one of claims 67-77, 85 or 86, wherein said input means reads digital information stored at a recording medium.

91. The apparatus as recited in any one of claims 67-77, 85 or 86, wherein the output means includes means for printing the encrypted information on printing.

92. The apparatus as recited in claim 91, wherein the printing includes identification documents (e.g., passport, identification card, driver's license, student identification card, public official identification card, medical insurance card etc.); paper money, bill, securities, gift certificate, membership card, and various certificates issued by government and municipal offices (e.g., certificate of a seal impression, register certified copy etc.); a card (credit card etc.); and a bankbook.

93. The apparatus as recited in claim 91, wherein the means for printing prints particular information on the printings on which the encrypted information is printed.

94. The apparatus as recited in any one of claims 67-77, 85 or 86, wherein said output means further includes a display unit for displaying the encrypted information.

95. The apparatus as recited in any one of claims 67-77, 85 or 86, wherein said output means further a communication unit for transmitting the encrypted information to an external device.

96. An apparatus for decrypting information on a basic element by basic element basis, comprising:
an input means for receiving encrypted information;
a security code obtaining means used for obtaining a security code;
a decryption means for decrypting the encrypted information on a basic element by basic element basis, composing the decrypted basic elements and generating restored information;
a storing means for storing the restored information; and
an output means for outputting the restored information.

97. The apparatus as recited in claim 96, wherein said decryption means performs a multi step decryption including a position converting procedure which inverse-changes positions of the basic elements based on the random number maps and a color converting procedure which inverse-changes colors of the basic elements received through the input means based on the gray scale map.

98. The apparatus as recited in claim 97, wherein said decryption means includes:
means for primary decryption decomposing the encrypted information into a plurality of basic elements and inverse-puzzling the basic elements based on the random number map, and generating inverse-puzzled basic elements;
means for secondary decryption dividing the inverse-puzzled basic elements into multiple channels, generating a gray scale map, mapping the inverse-puzzled basic elements to the gray scale map and generating color-restored basic elements; and
means for third decryption re-inverse-puzzling the color-restored basic elements based on the random number maps and generating re-inverse-puzzled basic elements.

99. The apparatus as recited in claim 97, wherein said decryption means includes:
means for primary decryption decomposing the encrypted information into a plurality of basic elements and inverse-puzzling the basic elements based on the random number map, and generating inverse-puzzled basic elements;
means for secondary decryption dividing the inverse-puzzled basic elements into multiple channels, re-inverse-puzzling each channel of the inverse-puzzled basic elements based on the random number map and generating an re-inverse-puzzled basic elements; and
means for third decryption generating a gray scale map, mapping the re-inverse-puzzled basic elements to the gray scale map and generating color-restored basic elements.

100. The apparatus as recited in claim 97, wherein said decryption means includes:
means for primary decryption decomposing the encrypted information into a plurality of basic elements, generating a gray scale map, mapping the basic elements to the gray scale map and generating color-restored basic elements;
means for secondary decryption inverse-puzzling the color-restored basic elements based on the random number map and generating inverse-puzzled basic elements; and
means for third decryption dividing the inverse-puzzled basic elements into multiple channels, re-inverse-puzzling each channel of the inverse-puzzled basic elements based on the random number map and generating re-inverse-puzzled basic elements.

101. The apparatus as recited in claim 97, wherein said decryption means includes:
means for primary decryption inverse-puzzling the basic elements based on the random number map and generating inverse-puzzled basic elements; and
means for secondary decryption generating a gray scale map, mapping the inverse-puzzled basic elements to the gray scale map and generating color-restored basic elements.

102. The apparatus as recited in claim 97, wherein said decryption means includes:
means for primary decryption decomposing the encrypted information to a plurality of basic elements and inverse-puzzling the basic elements based on the random number map and generating inverse-puzzled basic elements; and
means for secondary decryption generating a gray scale map, mapping the inverse-puzzled basic elements to the gray scale map and generating color-restored basic elements.

103. The apparatus as recited in claim 97, wherein said decryption means includes:
means for primary decryption generating a gray scale map, mapping the basic elements to the gray scale map and generating color-restored basic elements; and
means for secondary decryption inverse-puzzling the color-restored basic elements based on the random number maps and generating inverse-puzzled basic elements.

104. The apparatus as recited in claim 97, wherein said decryption means includes:
means for primary decryption decomposing the encrypted information into a plurality of basic elements and generating a gray scale map, mapping the basic elements to the gray scale map and generating color-restored basic elements; and
means for primary decryption inverse-puzzling the color-restored basic elements based on the random number maps and generating inverse-puzzled basic elements.

105. The apparatus as recited in claim 97, wherein said decryption means includes:
means for primary decryption inverse-puzzling one channel of the basic elements based on the random number map and generating inverse-puzzled basic elements;
means for secondary decryption generating a gray scale map, mapping the inverse-puzzled basic elements to the gray scale map and generating color-restored basic elements; and
means for generating the other channels of basic elements based on the color-restored basic elements.

106. The apparatus as recited in claim 97, wherein said decryption means includes:
means for primary decryption generating a gray scale map, mapping the basic elements to the gray scale map and generating color-restored basic elements;
means for primary decryption inverse-puzzling the color-restored basic elements based on the random number map and generating inverse-puzzled basic elements; and
means for generating the other channels of basic elements based on the inverse-puzzled basic elements.

107. The apparatus as recited in claim 105 or 106, wherein said decryption means further performs the function of converting pixels of the encrypted information to one channel of basic elements.

108. The apparatus as recited in any one of claims 98 to 104, wherein said decryption means further performs the function of converting pixels of the encrypted information to basic elements.

109. The apparatus as recited in any one of claims 97 to 106, wherein the gray scale map is a one-color gray scale map.

110. The apparatus as recited in claim 109, wherein the gray scale map includes a yellow gray scale map.

111. The apparatus as recited in any one of claims 97 to 106, wherein the gray scale map is a multi-color gray scale map.

112. The apparatus as recited in claim 96, wherein said decryption means decrypts the encrypted image by inverse-puzzling positions of the basic elements based on the random number maps.

113. The apparatus as recited in claim 112, wherein said decryption means decrypts the encrypted information by inverse-puzzling positions of the basic elements based on the random number maps.

114. The apparatus as recited in any one of claims 96-106, 112 or 113, wherein the decryption means further includes means for correcting a skew and a size of the encrypted information for normalization.

115. The apparatus as recited in any one of claims 96-106, 112 or 113, wherein the decryption means further includes mean for performing a correction procedure of the restored information by eliminating miscellaneous image from the restored information.

116. The apparatus as recited in claim 115, wherein the correction procedure includes the steps of:
performing a primary restoration by utilizing a spatial filtering technique having an optimum similarity in which information of neighboring pixel is used, in case there is a miscellaneous image on the restored information; and
performing a secondary restoration executing an inverse-estimation and restoration using a restored value of the neighboring pixel of the neighborhood in case that all the neighboring pixels are part of the miscellaneous image.

117. The apparatus as recited in any one of claims 96-106, 112 or 113, wherein said decryption means compares the original information stored in a database with the restored information, determines whether there is forgery or not, and displays its result.

118. The apparatus as recited in any one of claims 96-106, 112 or 113, wherein said decryption means compares the digitized additional information printed on the encrypted information, with the restored information, determines whether there is forgery or not, and displays its result.

119. The apparatus as recited in any one of claims 96-106, 112 or 113, wherein said decryption means compares the digitized information from other information on the printing, with the restored information, determines whether there is forgery or not, and displays its result.

120. The apparatus as recited in any one of claims 96-106, 112 or 113, wherein said output means outputs the restored information together with the original information.

121. The apparatus as recited in any one of claims 96-106, 112 or 113, wherein said input means reads the encrypted information printed on a printing in digital type.

122. The apparatus as recited in claim 59, wherein the printing includes identification documents (e.g., passport, identification card, driver's license, student identification card, public official identification card, medical insurance card etc.); paper money, bill, securities, gift certificate, membership card, and various certificates issued by government and municipal offices (certificate of a seal impression, register certified copy etc.); a card (credit card etc.); and a bankbook.

123. The apparatus as recited in any one of claims 96-106, 112 or 113, wherein said input means reads the encrypted information, which is digital information stored in a record medium.

124. The apparatus as recited in any one of claims 96-106, 112 or 113, wherein said input means receives the encrypted information from an encryption apparatus.

125. The apparatus as recited in any one of claims 96-106, 112 or 113, wherein said security code obtaining means extracts an encryption key from the encrypted information, decrypts the encryption key and then restores the security code.

126. The apparatus as recited in any one of claims 96-106, 112 or 113, wherein said security code obtaining means includes a security code input unit for receiving the security code.

127. A method for encrypting/decrypting information on a basic element-by-basic element basis, comprising the steps of:
a) receiving information to be encrypted;
b) generating random number maps for an encryption;
c) decomposing the information to be encrypted into a plurality of basic elements;
d) performing a multi step encryption of the basic elements and generating encrypted information;
e) outputting the encrypted information;
f) receiving the encrypted information;
g) obtaining a security code used for decrypting the encrypted information;
h) generating random number maps for a decryption;
i) performing a multi step decryption of the encrypted information on a basic element by basic element basis;
j) restoring an original image by composing the decrypted basic elements and generating restored information; and
k) outputting the restored information.

128. An apparatus for encrypting/decrypting information on a basic element-by-basic element basis, said apparatus comprising:
an input means for receiving encrypted information and information to be encrypted;
a security code obtaining means for obtaining a security code for an encryption;
a multi step encryption means for performing a multi step encryption by decomposing the information into a plurality of basic elements, and changing a position of the basic element based on a random number map for an encryption and a color of the basic element based on a gray scale map;
a security code obtaining means for obtaining a security code for a decryption;
a multi step decryption means for performing a multi step decryption by inverse-changing the position of the basic element based on the random number map and the color of the basic element based on the gray scale map, and then, restoring original information by composing the decrypted basic elements and generating restored information;
a storing means for storing the encrypted information and the restored information; and
an output means for outputting the encrypted information and the restored information.

129. A computer readable recording medium storing instructions for executing a method for encrypting information on a basic element-by-basic element basis, the method comprising the steps of:
a) receiving information to be encrypted;
b) generating random number maps;
c) decomposing the information into a plurality of basic elements which are classified into multiple channels;
d) encrypting the basic elements and generating encrypted information; and
e) outputting the encrypted information.

130. The computer readable record medium as recited in claim 129, the method further comprising the step of f) changing a color and a size of the information to be encrypted for normalization.

131. The computer readable record medium as recited in claim 129 or 130, the method further comprising the steps of:
g) encrypting a security code and generating an encryption key; and
h) inserting the encryption key into the encrypted information.

132. A computer readable recording medium storing instructions for executing a method for decrypting information on a basic element-by-basic element basis, the method comprising the steps of:
a) receiving encrypted information;
b) obtaining a security code used for decrypting the encrypted information;
c) generating random number maps;
d) decrypting the encrypted information on a basic element by basic element basis and generating decrypted basic elements;
e) composing the decrypted basic elements and generating restored information; and
f) outputting the restored information.

133. The computer readable record medium as recited in claim 130, the method further comprising step g) correcting a skew and a size of the encrypted information for normalization.

134. The computer readable record medium as recited in claim 132 or 133, the method further comprising the step of h) performing correction of the restored information by eliminating a miscellaneous image from the restored information.

135. A computer readable recording medium storing instructions for executing a method for encrypting/decrypting information on a basic element-by-basic element basis, comprising the steps of:
a) receiving information to be encrypted;
b) generating random number maps for an encryption;
c) decomposing the information to be encrypted into a plurality of basic elements;
d) performing a multi step encryption of the basic elements and generating encrypted information;
e) outputting the encrypted information;
f) receiving the encrypted information;
g) obtaining a security code used for decrypting the encrypted information;
h) generating random number maps for a decryption;
i) performing a multi step decryption of the encrypted information on a basic element by basic element basis;
j) restoring an original image by composing the decrypted basic elements and generating restored information; and
k) outputting the restored information.
